(19) United States
(12) Patent Application Publication
(10) Pub. No.: US 2007/0089244 A1
(43) Pub. Date: Apr. 26, 2007

(54) Textile care product

(76) Inventor: Josef Penninger, Hilden (DE)

Correspondence Address: PAUL & PAUL, 2000 MARKET STREET, PHILADELPHIA, PA, 19103-3229, US

(21) Appl. No.: 11/546,962

(22) Filed: Oct. 12, 2006

Related U.S. Application Data
(63) Continuation of application No. PCT/EP05/04079, filed on Apr. 18, 2006.

(30) Foreign Application Priority Data
Apr. 21, 2004 (DE) 10 2004 020 015.7

(51) Int. Cl. C11D 3/00

(52) U.S. Cl. 8/115.51

(57) ABSTRACT

A textile care product comprising quaternary nitrogen containing cellulose ether, for protecting textiles. The product can be used in order to reduce fluffing, to reduce pilling, to reduce creasing, for smoothing and to improve soft touch, in addition to facilitating ironing of a flat textile sheet material.

### CROSS-REFERENCE TO RELATED APPLICATIONS.

This application is a continuation under 35 U.S.C. §365(c) and 35 U.S.C. §120 of International Application No. PCT/EP2005/004079, filed Apr. 18, 2005. This application also claims priority under 35 U.S.C. §119 of German Patent Application No. DE 10 2004 020 015.7, filed Apr. 21, 2004. Both the International Application and the German Application are incorporated herein by reference in their entireties.

### STATEMENT REGARDING FEDERALLY SPONSORED RESEARCH OR DEVELOPMENT.

Not Applicable

### INCORPORATION-BY-REFERENCE OF MATERIAL SUBMITTED ON A COMPACT DISC.

Not Applicable

### BACKGROUND OF THE INVENTION

(1) Field of the Invention

The invention relates to a textile care composition comprising a cellulose ether having quaternized nitrogen atom in the ether moiety, and to a washing process for washing textiles using this textile laundry detergent in a domestic washing machine. The invention further relates to the use of the textile laundry detergent for reducing crease formation, improving ironing properties and improving elasticity.

Modern textile cleaning places high demands on the items of laundry to be cleaned. Thus, the frequent washing of items of clothing in a washing machine and the subsequent drying in a tumble dryer is associated with high mechanical stress on the fabric. The frictional forces lead in many cases to damage to the textile fabric, recognizable by fuzzing and pilling. With each washing or drying operation, but also as a result of wearing the items of clothing, further abrasion and/or breakage of tiny fibers on the surface of the textile fabrics takes place. The conventional textile cleaning compositions are incapable of preventing this damage to the fiber or merely attempt to remove existing textile damage.

(2) Description of Related Art, Including Information Disclosed Under 37 C.F.R. §§1.97 and 1.98

International Patent Application WO 99/16956 A1 proposes the removal of fuzz or pills by use of cellulases. The cellulases degrade microfibers protruding from the textile fabrics and thus ensure a smooth and therefore pill-free textile surface.

A further great disadvantage of the mechanical stress on textile fabrics is the formation of creased textile surfaces undesired by the consumer, and also the formation of rough surfaces. Both the rough textile surfaces and the creasing of the fabric which arises lead to a considerable worsening of the sliding properties of irons or other textile smoothing devices. The effort of ironing rough and creased textiles is not only higher exertion but also a considerable increased time demand. In the prior art, solutions for the improvement of the ironing properties of washed textiles can be found mainly in the field of after-treatment compositions. For example, International Patent Application WO 00/77134 proposes the use of oxidized polyolefins in fabric softener formulations for improving the ironing properties.

The use of celluloses, hydrogels and acrylic acid polymers as fuzz reduction components in textile treatment compositions is known from German Patent Application DE 102 03 192 A1.

The U.S. Pat. No. 3,472,840 describes quaternary nitrogen-containing cellulose ethers of the general formula (I)
((R—O—)₃R_{cell})_{y} (I)
in which R_{cell} is an anhydroglucose radical (C₆H₁₀O₅), the degree of polymerization y is from 50 to 20,000, and each of the R radicals corresponds to the general formula (II) 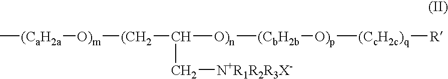
in which a and b are each independently 2 or 3, c is 1, 2 or 3, m and p are each independently an integer from 0 to 10, n is an integer from 0 to 3, q is 0 or 1, X⁻ is an anion which, according to its charge, is present in such a number that it balances the positive charges of the quaternary nitrogen atoms, and R′ is hydrogen, a carboxylic acid group or a sodium carboxylate, potassium carboxylate or ammonium carboxylate group, with the proviso that R′ is hydrogen when q is 0. The compounds of the formula (I) may, as described there, be obtained by reacting customary nonionic cellulose ethers, or those prepared especially beforehand, with quaternary halohydrins or quaternary epoxides.

### BRIEF SUMMARY OF THE INVENTION

It has now been found that, surprisingly, the use of such quaternary nitrogen-containing cellulose ethers in the washing process leads to a significant improvement in the fiber and textile properties.

The present invention therefore provides, in a first embodiment, a textile care composition comprising quaternary nitrogen-containing cellulose ethers of the general formula (I)
((R—O—)₃R_{cell})_{y} (I)
in which R_{cell} is an anhydroglucose radical (C₆H₁₀O₅), the degree of polymerization y is from 50 to 20,000, and each of the R radicals corresponds to the general formula (II) 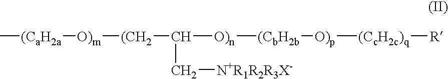
in which a and b are each independently 2 or 3, c is 1, 2 or 3, m and p are each independently an integer from 0 to 10, n is an integer from 0 to 3, q is 0 or 1, X⁻ is an anion which, according to its charge, is present in such a number that it balances the positive charges of the quaternary nitrogen atoms, and R′ is hydrogen, a carboxylic acid group or a sodium carboxylate, potassium carboxylate or ammonium carboxylate group, with the proviso that R′ is hydrogen when q is 0.

### BRIEF DESCRIPTION OF THE SEVERAL VIEWS OF THE DRAWING(S)

Not Applicable

### DETAILED DESCRIPTION OF THE INVENTION

In the context of this invention, textile care compositions are understood to mean both washing and cleaning compositions and pretreatment compositions, and compositions for conditioning textile fabrics such as mild-action laundry detergents and after-treatment compositions such as fabric softeners. Conditioning is understood to mean the softening treatment of textile fabrics, materials, yarns and fabrics. The conditioning is intended to impart positive properties to the textiles, for example, improved softness, increased shine and color brilliance, odor freshening, and reduction in the creasing behavior and in the static charge.

When inventive compositions are used, in particular, the creasing of textiles by the washing and/or drying process is prevented, the ironing properties of the textile are improved and the tendency of the textiles to become baggy in the course of washing is reduced considerably.

The inventive textile care compositions may be present either in solid form, for example, as a powder, granule, extrudate, pressed and/or molten molding or as a tablet, or in liquid form, for example, as a dispersion, suspension, emulsion, solution, microemulsion, gel or paste. In a preferred embodiment of the invention, they are liquid. The inventive compositions contain preferably from 0.1% by weight to 5% by weight, in particular from 0.1% by weight to 1% by weight, of quaternary nitrogen-containing cellulose ether of the general formula (I). In the compounds of the formula (I), y is preferably in the range from 200 to 5,000. Per anhydroglucose unit R_{cell}, n, as a mean value, is preferably from 0.01 to 1, in particular from 0.1 to 0.5, i.e., averaged over the entire cellulose ether, in particular, every tenth to every second anhydroglucose unit is substituted by a group bearing a quaternary nitrogen atom. The sum of m, n, p and q, per anhydroglucose unit R_{cell}, as a mean value, is preferably from 0.01 to 4, in particular from 0.1 to 2 and more preferably from 0.8 to 2.

In addition to the groups bearing the quaternary nitrogen atom, the cellulose ethers to be used in accordance with the invention preferably contain methyl, ethyl, propyl, hydroxyethyl and/or hydroxypropyl groups. These groups constitute some of the R radicals and/or, as the sub-moiety —(C_{b}H_{2b}—O)ₚ—(C_{c}H_{2c})_{q}—R′, are part of the group bearing the quaternary nitrogen atom.

The mean molecular weight Mw of the cellulose ethers to be used in accordance with the invention is preferably above 5,000 g/mol, more preferably above 10,000 g/mol, in particular above 15,000 g/mol, advantageously between 30,000 and 250,000 g/mol, exceptionally preferably between 50,000 and 100,000 g/mol. The molecular weight can be determined by gel permeation chromatography against standardized polyacrylic acid standards.

In a preferred embodiment of the present invention, the textile care compositions comprise complexing agents in addition to the cellulose ethers with a quaternary nitrogen atom. It has been found that, surprisingly, organic, advantageously water-soluble, complexing agents in particular can be incorporated particularly efficiently into the inventive textile care compositions and, especially together with the cellulose ethers to be used in accordance with the invention, impart increased stability to the textile care compositions, including the liquid formulations in particular. The complexing agents improve the stability of the compositions and protect, for example, against the decomposition of certain ingredients of washing-active formulations catalyzed by heavy metals. Together with the cellulose ethers to be used in accordance with the invention, they contribute to the inhibition of incrustations. The group of the complexing agents includes, for example, the salts, especially the alkali metal salts of nitrilotriacetic acid (NTA) and derivatives thereof, and also alkali metal salts of anionic polyelectrolytes such as polymaleates and polysulfonates. Also suitable are citric acid, adipic acid, succinic acid, glutaric acid, malic acid, tartaric acid, maleic acid, fumaric acid, sugar acids, aminocarboxylic acids and derivatives thereof, and also mixtures of these. Preferred compounds include in particular organophosphonates, for example, 1-hydroxyethane-1,1-diphosphonic acid (HEDP), aminotri(methylenephosphonic acid) (ATMP), diethylenetriaminepenta(methylenephosphonic acid) (DTPMP or DETPMP) and 2-phosphonobutane-1,2,4-tricarboxylic acid (PBS-AM), which are usually used in the form of their ammonium or alkali metal salts. Particular preference is given in the context of the present invention to citric acid and/or alkali metal salts thereof, for example, sodium citrate and/or potassium citrate. In a preferred embodiment, the textile care compositions comprise complexing agents in an amount up to 20% by weight, preferably from 0.01 to 15% by weight, more preferably from 0.1 to 10% by weight and in particular from 0.3 to 5.0% by weight, advantageously from 1.5 to 3% by weight, based in each case on the overall composition.

In a preferred embodiment, the inventive textile care compositions additionally comprise nonionic surfactants. The use of nonionic surfactants not only increases the washing performance of the inventive compositions but additionally promotes the dispersion and homogeneous distribution of the cellulose ether to be used in accordance with the invention.

The nonionic surfactants used are preferably alkoxylated, advantageously ethoxylated and/or propoxylated, especially primary alcohols having preferably from 8 to 18 carbon atoms and on average from 1 to 12 mol of ethylene oxide (EO) and/or from 1 to 10 mol of propylene oxide (PO) per mole of alcohol. Particular preference is given to C₈-C₁₆-alcohol alkoxylates, advantageously ethoxylated and/or propoxylated C₁₀-C₁₅-alcohol alkoxylates, in particular C₁₂-C₁₄-alcohol alkoxylates, having a degree of ethoxylation between 2 and 10, preferably between 3 and 8, and/or a degree of propoxylation between 1 and 6, preferably between 1.5 and 5. The alcohol radical may preferably be linear or more preferably 2-methyl-branched, or may contain a mixture of linear and methyl-branched radicals, as are typically present in oxo alcohol radicals. However, especially preferred alcohol ethoxylates have linear radicals from alcohols of native origin which have from 12 to 18 carbon atoms, for example, from coconut, palm, tallow fat or oleyl alcohol, and on average from 2 to 8 EO per mole of alcohol. The preferred ethoxylated alcohols include, for example, C₁₂₋₁₄-alcohols having 3 EO or 4 EO, C₉₋₁₁-alcohol having 7 EO, C₁₃₋₁₅-alcohols having 3 EO, 5 EO, 7 EO or 8 EO, C₁₂₋₁₈-alcohols having 3 EO, 5 EO or 7 EO, and mixtures thereof, such as mixtures of C₁₂₋₁₄-alcohol having 3 EO and C₁₂₋₁₈-alcohol having 5 EO. The degrees of ethoxylation and propoxylation specified constitute statistical average values which may be an integer or a fraction for a specific product. Preferred alcohol ethoxylates and propoxylates have a narrowed homolog distribution (narrow range ethoxylates/propoxylates, NRE/NRP). In addition to these nonionic surfactants, it is also possible to use fatty alcohols having more than 12 EO. Examples thereof are tallow fat alcohol having 14 EO, 25 EO, 30 EO or 40 EO.

Also suitable are alkoxylated amines, advantageously ethoxylated and/or propoxylated, especially primary and secondary amines having preferably from 1 to 18 carbon atoms per alkyl chain and on average from 1 to 12 mol of ethylene oxide (EO) and/or from 1 to 10 mol of propylene oxide (PO) per mole of amine.

Especially for use in non-aqueous inventive formulations, it has been found that the end group-capped alkoxylated fatty amines and fatty alcohols are particularly advantageous. The terminal hydroxyl groups of the fatty alcohol alkoxylates and fatty amine alkoxylates are etherified by C₁-C₂₀-alkyl groups, preferably methyl or ethyl groups, in the end group-capped fatty alcohol alkoxylates and fatty amine alkoxylates.

In addition, further nonionic surfactants which may be used are also alkyl glycosides of the general formula RO(G)ₓ, for example, in the form of compounds, particularly with anionic surfactants, in which R is a primary straight-chain or methyl-branched, in particular 2-methyl-branched, aliphatic radical having from 8 to 22, preferably from 12 to 18, carbon atoms and G is the symbol which represents a glycose unit having 5 or 6 carbon atoms, preferably glucose. The degree of oligomerization x, which specifies the distribution of monoglycosides and oligoglycosides, is any number between 1 and 10; x is preferably from 1.2 to 1.4.

A further class of nonionic surfactants used with preference, which are used either as the sole nonionic surfactant or in combination with other nonionic surfactants, is that of alkoxylated, preferably ethoxylated or ethoxylated and propoxylated, fatty acid alkyl esters, preferably having from 1 to 4 carbon atoms in the alkyl chain, in particular fatty acid methyl esters, as are described, for example, in Japanese Patent Application JP 58/217598 or which are prepared preferably by the process described in International Patent Application WO-A-90/13533.

Further useful surfactants are what are known as gemini surfactants. These generally refer to those compounds which have two hydrophilic groups and two hydrophobic groups per molecule. These groups are generally separated from each other by a spacer. This spacer is generally a carbon chain which should be sufficiently long that the hydrophilic groups have adequate separation so that they can act independently of one another. Such surfactants generally feature an unusually low critical micelle concentration and the ability to greatly reduce the surface tension of water. However, the term gemini surfactants refers in exceptional cases not only to dimeric, but also to trimeric surfactants.

Suitable gemini surfactants are, for example, sulfated mixed hydroxy ethers according to German Patent Application DE-A-43 21 022 or dimer alcohol bis- and trimer alcohol trissulfates and ether sulfates according to International Patent Application WO-A-96/23768. End group-capped dimeric and trimeric mixed ethers according to German Patent Application DE-A-195 13 391 have the particular feature of their bi- and multifunctionality. For instance, the end group-capped surfactants mentioned have good wetting properties and are low-foaming, so that they are especially suitable for use in machine washing or cleaning processes.

However, it is also possible to use gemini polyhydroxy fatty acid amides or poly(polyhydroxy fatty acid amides), as described in International Patent Applications WO-A-95/19953, WO-A-95/19954 and WO-A-95/19955.

Further suitable surfactants are polyhydroxy fatty acid amides of the following formula 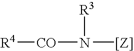
in which R⁴CO is an aliphatic acyl radical having from 6 to 22 carbon atoms, R³ is hydrogen, an alkyl or hydroxyalkyl radical having from 1 to 4 carbon atoms and [Z] is a linear or branched polyhydroxyalkyl radical having from 3 to 10 carbon atoms and from 3 to 10 hydroxyl groups. The polyhydroxy fatty acid amides are known substances which can typically be obtained by reductively aminating a reducing sugar with ammonia, an alkylamine or an alkanolamine, and subsequently acylating with a fatty acid, a fatty acid alkyl ester or a fatty acid chloride.

The group of polyhydroxy fatty acid amides also includes compounds of the following formula 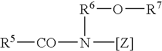
in which R⁵ is a linear or branched alkyl or alkenyl radical having from 7 to 12 carbon atoms, R⁶ is a linear, branched or cyclic alkyl radical or an aryl radical having from 2 to 8 carbon atoms and R⁷ is a linear, branched or cyclic alkyl radical or an aryl radical or an oxyalkyl radical having from 1 to 8 carbon atoms, preference being given to C₁₋₄-alkyl or phenyl radicals, and [Z] is a linear polyhydroxyalkyl radical whose alkyl chain is substituted by at least two hydroxyl groups, or alkoxylated, preferably ethoxylated or propoxylated, derivatives of this radical. [Z] is preferably obtained by reductive amination of a reduced sugar, for example, glucose, fructose, maltose, lactose, galactose, mannose or xylose. The N-alkoxy- or N-aryloxy-substituted compounds can then, for example, according to the teaching of International Application WO-A-95/07331, be converted to the desired polyhydroxy fatty acid amides by reaction with fatty acid methyl esters in the presence of an alkoxide as catalyst.

For the inventive textile care compositions, it has been found to be advantageous when nonionic surfactants selected from the group of the alkoxylated fatty alcohols and/or alkylglycosides, especially mixtures of alkoxylated fatty alcohols and alkylglycosides, are used.

In a preferred embodiment, the inventive textile care compositions comprise nonionic surfactants in amounts of up to 35% by weight, preferably from 5 to 25% by weight, more preferably from 10 to 20% by weight, based in each case on the overall composition.

Moreover, the inventive textile care compositions may also comprise anionic surfactants in addition to or in place of the nonionic surfactants. The use of anionic surfactants significantly increases the soil detachment performance of the inventive compositions during the washing operation, without significantly impairing the action of the cellulose ethers to be used in accordance with the invention—in spite of their cationic charge—as a fuzz reduction component and crease protection component.

The anionic surfactants used are, for example, those of the sulfonate and sulfate type. Useful surfactants of the sulfonate type are preferably C₉₋₁₃-alkylbenzenesulfonates, olefinsulfonates, i.e. mixtures of alkene- and hydroxyalkanesulfonates, and disulfonates, as are obtained, for example, from C₁₂₋₁₈-monoolefins with terminal or internal double bond by sulfonation with gaseous sulfur trioxide and subsequent alkaline or acidic hydrolysis of the sulfonation products. Also suitable are alkanesulfonates which are obtained from C₁₂₋₁₈-alkanes, for example, by sulfochlorination or sulfoxidation with subsequent hydrolysis or neutralization. The esters of a-sulfo fatty acids (ester sulfonates), for example, the a-sulfonated methyl esters of hydrogenated coconut, palm kernel or tallow fatty acids, are also likewise suitable.

Further suitable anionic surfactants are sulfated fatty acid glycerol esters. Fatty acid glycerol esters refer to the mono-, di- and triesters, and mixtures thereof, as are obtained in the preparation by esterification of a monoglycerol with from 1 to 3 mol of fatty acid or in the transesterification of triglycerides with from 0.3 to 2 mol of glycerol. Preferred sulfated fatty acid glycerol esters are the sulfation products of saturated fatty acids having from 6 to 22 carbon atoms, for example, of caproic acid, caprylic acid, capric acid, myristic acid, lauric acid, palmitic acid, stearic acid or behenic acid.

Preferred alk(en)yl sulfates are the alkali metal and in particular the sodium salts of the sulfuric monoesters of C₁₂-C₁₈ fatty alcohols, for example, of coconut fatty alcohol, tallow fatty alcohol, lauryl, myristyl, cetyl or stearyl alcohol, or of C₁₀-C₂₀ oxo alcohols and those monoesters of secondary alcohols of these chain lengths. Also preferred are alk(en)yl sulfates of the chain length mentioned which contain a synthetic straight-chain alkyl radical prepared on a petrochemical basis and which have analogous degradation behavior to the equivalent compounds based on fatty chemical raw materials. From the washing point of view, preference is given to the C₁₂-C₁₆-alkyl sulfates and C₁₂-C₁₅-alkyl sulfates, and C₁₄-C₁₅-alkyl sulfates. 2,3-Alkyl sulfates, which are prepared, for example, according to U.S. Pat. No. 3,234,258 or 5,075,041, and can be obtained as commercial products from the Shell Oil Company under the name DAN®, are also suitable anionic surfactants.

Suitable amionic surfactants particularly preferred in the context of this invention are also the sulfuric monoesters of the straight-chain or branched C₇₋₂₁-alcohols ethoxylated with 1 to 6 mol of ethylene oxide, such as 2-methyl-branched C₉₋₁₁-alcohols with on average 3.5 mol of ethylene oxide (EO) or C₁₂₋₁₈-fatty alcohols with from 1 to 4 EO, which are referred to as fatty alcohol ether sulfates.

Further suitable anionic surfactants are also the salts of alkylsulfosuccinic acid, which are also referred to as sulfosuccinates or as sulfosuccinic esters and are the monoesters and/or diesters of sulfosuccinic acid with alcohols, preferably fatty alcohols and in particular ethoxylated fatty alcohols. Preferred sulfosuccinates contain C₈₋₁₈ fatty alcohol radicals or mixtures thereof. Especially preferred sulfosuccinates contain a fatty alcohol radical which is derived from ethoxylated fatty alcohols which, considered alone, constitute nonionic surfactants. In this context, particular preference is in turn given to sulfosuccinates whose fatty alcohol radicals derive from ethoxylated fatty alcohols with a narrowed homolog distribution. It is also equally possible to use alk(en)ylsuccinic acid having preferably from 8 to 18 carbon atoms in the alk(en)yl chain or salts thereof.

Useful further anionic surfactants are in particular soaps. Suitable soaps are saturated fatty acid soaps, such as the salts of lauric acid, myristic acid, palmitic acid, stearic acid, hydrogenated erucic acid and behenic acid, and soap mixtures derived in particular from natural fatty acids, for example, coconut, palm kernel or tallow fatty acids.

The anionic surfactants including the soaps may be present in the form of their sodium, potassium or ammonium salts, and also in the form of soluble salts of organic bases, such as mono-, di- or triethanolamine. The anionic surfactants are preferably present in the form of their sodium or potassium salts, in particular in the form of the sodium salts. For the inventive non-aqueous liquid laundry detergents, however, preference is given to the ammonium salts, especially the salts of organic bases, for example, isopropylamine.

A further class of anionic surfactants is the class of ethercarboxylic acids obtainable by reaction of fatty alcohol ethoxylates with sodium chloroacetate in the presence of basic catalysts. They have the general formula: R¹⁰O—(CH₂—CH₂—O)ₚ—CH₂—COOH where R¹⁰=C₁-C₁₈ and p=from 0.1 to 20. Ethercarboxylic acids are water hardness-insensitive and have outstanding surfactant properties. Preparation and use are described, for example, in Seifen, Öle, Fette, Wachse 101, 37 (1975); 115, 235 (1989) and Tenside Deterg. 25, 308 (1988).

In a preferred embodiment, the inventive textile cleaning compositions comprise anionic surfactants, preferably selected from the group of the fatty alcohol sulfates and/or fatty alcohol ether sulfates and/or alkylbenzenesulfonates and/or soaps.

Depending on the end use of the inventive textile care compositions, the content of anionic surfactants may vary considerably. When the textile care compositions are in the form of mild-action laundry detergents or after-treatment compositions, for example, of fabric softeners, the amounts are normally below 10% by weight, preferably below 5% by weight and in particular below 1% by weight, based in each case on the overall composition.

When the textile care compositions are present in the form of a solid or liquid heavy-duty laundry detergent, for example, as a non-aqueous liquid laundry detergent, anionic surfactants may be present in amounts up to 65% by weight, preferably in amounts up to 50% by weight, more preferably in amounts of from 5 to 35% by weight, based in each case on the overall composition.

In a preferred embodiment, the inventive textile care compositions may further additionally comprise enzymes.

Enzymes support the washing processes in various ways, especially in the removal of soiling which is difficult to bleach, for example, protein stains. The incorporation of enzymes into laundry detergent formulations, especially into liquid textile care compositions, however, frequently presents problems, since there can be incompatibilities with other laundry detergent constituents, which can in turn bring about an activity loss of the enzymes. It has been found that, surprisingly, the use of the copolymers to be used in accordance with the invention allows the stability of the enzymes in wash liquor or textile care composition formulation, especially in liquid textile care composition formulations, to be improved.

Useful enzymes are in particular those from the classes of hydrolases, such as the proteases, esterases, lipases and lipolytic enzymes, amylases, cellulases and other glycosyl hydrolases and mixtures of the enzymes mentioned. In the wash, all of these hydrolases contribute to the removal of marks, such as protein, grease or starch marks, and graying. Moreover, cellulases and other glycosyl hydrolases may, by removing pilling and microfibrils, contribute to color retention and to an increase in the softness of the textile. For bleaching or for inhibiting dye transfer it is also possible to use oxireductases. Particularly suitable enzymatic active ingredients are those obtained from bacterial strains or fungi, such as Bacillus subtilis, Bacillus licheniformis, Streptomyceus griseus and Humicola insolens. Preference is given to using proteases of the subtilisin type and in particular proteases obtained from Bacillus lentus. Of particular interest in this context are enzyme mixtures, for example, mixtures of protease and amylase or protease and lipase or lipolytic enzymes or protease and cellulase or mixtures of cellulase and lipase or lipolytic enzymes or mixtures of protease, amylase and lipase or lipolytic enzymes or protease, lipase or lipolytic enzymes and cellulase, but in particular protease and/or lipase-containing mixtures, or mixtures containing lipolytic enzymes. Examples of lipolytic enzymes of this kind are the known cutinases. Peroxidases or oxidases have also been found to be suitable in some cases. Suitable amylases include in particular α-amylases, isoamylases, pullulanases and pectinases. The cellulases used are preferably cellobiohydrolases, endoglucanases and β-glucosidases, which are also called cellobiases, or mixtures thereof. Since different cellulase types differ in their CMCase and avicelase activities, it is possible to attain the desired activities by selective mixing of the cellulases.

The enzymes may be adsorbed on supports or coated in order to protect them against premature decomposition.

In a preferred embodiment, the inventive textile care compositions comprise enzymes, preferably selected from the group of the proteases and/or amylases and/or cellulases.

When the inventive textile care compositions are in the form of mild-action laundry detergents or after-treatment compositions, for example, in the form of fabric softeners, they may, in a preferred embodiment, comprise cellulase, preferably in an amount of from 0.005 to 2% by weight, more preferably from 0.01 to 1% by weight, in particular from 0.02 to 0.5% by weight, based in each case on the overall composition.

In a preferred embodiment, the inventive textile care compositions are in liquid form and advantageously have a viscosity of from 50 to 5,000 mPas, more preferably from 50 to 3,000 mPas and in particular from 500 to 1,500 mPas (measured at 20° C. with a rotary viscometer (Brookfield RV, spindle 2) at 20 rpm (rpm: revolutions per minute)).

In a preferred embodiment, preferred liquid textile care compositions comprise one or more non-aqueous water-miscible solvents.

Solvents which may be used in the inventive aqueous compositions stem, for example, from the group of mono- or polyhydric alcohols, alkanolamines or glycol ethers, as long as they are miscible with water in the concentration range specified. The solvents are preferably selected from ethanol, n- or i-propanol, butanols, glycol, propane- or butanediol, glycerol, diglycol, propyl- or butyldiglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, butoxypropoxypropanol (BPP), dipropylene glycol monomethyl or monoethyl ether, diisopropylene glycol monomethyl or monoethyl ether, methoxy-, ethoxy- or butoxytriglycol, 1-butoxyethoxy-2-propanol, 3-methyl-3-methoxybutanol, propylene glycol t-butyl ether, and mixtures of these solvents.

Some glycol ethers are obtainable under the trade names Arcosolv® (Arco Chemical Co.) or Cellosolve®, Carbitol® or Propasol® (Union Carbide Corp.); these also include, for example, ButylCarbitol®, HexylCarbitol®, MethylCarbitol® and Carbitol® itself, (2-(2-ethoxy)ethoxy)ethanol. The selection of the glycol ether can be made readily by those skilled in the art on the basis of its volatility, water solubility, its percentage by weight in the overall dispersion and the like. Pyrrolidone solvents such as N-alkylpyrrolidones, for example, N-methyl-2-pyrrolidone or N—C₈-C₁₂-alkylpyrrolidone, or 2-pyrrolidone may likewise be used. Alcohols may also be used with preference. They include liquid polyethylene glycols having a relatively low molecular weight, for example, polyethylene glycols having a molecular weight of 200, 300, 400 or 600. Further suitable other alcohols are, for example, lower alcohols such as ethanol, propanol, isopropanol and n-butanol, C₂-C₄-polyols such as diols or triols, for example, ethylene glycol, propylene glycol, glycerol or mixtures thereof.

When they are in liquid form, the inventive textile care compositions comprise, in a preferred embodiment, up to 95% by weight, more preferably from 20 to 90% by weight and in particular from 50 to 80% by weight of one or more solvents, preferably water-soluble solvents, and in particular water.

In a preferred embodiment of the invention, the textile care compositions additionally comprise softener components, preferably cationic surfactants. Especially when the inventive textile care compositions are in the form of mild-action laundry detergents or textile after-treatment compositions, for example, of fabric softeners, the use of additional softener components has been found to be extremely advantageous. Especially in the case of washing of sensitive textiles, for example, silk, wool or linen, which are washed and ironed at low temperatures, the use of softener components has been found to be useful. In addition to the cellulose ethers to be used in accordance with the invention, the softener components additionally ease the ironing of the textiles and reduce the static charge of the textile materials.

Examples of fabric-softening components are quaternary ammonium compounds, cationic polymers and emulsifiers as used in hair care compositions and also in textile-coating compositions.

Suitable examples are quaternary ammonium compounds of the formulae (III) and (IV) 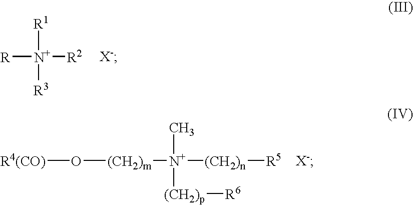
where, in (III), R and R¹ each represent an acyclic alkyl radical having from 12 to 24 carbon atoms, R² represents a saturated C₁-C₄-alkyl or hydroxyalkyl radical, R³ is either the same as R, R¹ or R² or represents an aromatic radical. X⁻ represents either a halide, methosulfate, methophosphate or phosphate ion and also mixtures thereof. Examples of cationic compounds of the formula (III) are didecyidimethylammonium chloride, ditallowdimethylammonium chloride or dihexadecylammonium chloride.

Compounds of the formula (IV) are known as ester quats. Ester quats are notable for their good biodegradability and are particularly preferred in the context of the present invention. In the formula (IV), R⁴ represents an aliphatic alkyl radical having from 12 to 22 carbon atoms and 0, 1, 2 or 3 double bonds; R⁵ represents H, OH or O(CO)R⁷, R⁶, independently of R⁵, represents H, OH or O(CO)R⁸, where R⁷ and R⁸ are each independently an aliphatic alkyl radical having from 12 to 22 carbon atoms and 0, 1, 2 or 3 double bonds m, n and p may each independently be 1, 2 or 3. X⁻ may be either a halide, methosulfate, methophosphate or phosphate ion, and also mixtures thereof. Preference is given to compounds where R⁵ is O(CO)R⁷ and R⁴ and R⁷ are alkyl radicals having from 16 to 18 carbon atoms. Particular preference is given to compounds wherein R⁶ also represents OH. Examples of compounds of the formula (IV) are methyl-N-(2-hydroxyethyl)-N,N-di-(tallowacyloxyethyl)ammonium methosulfate, bis-(palmitoyl)ethylhydroxyethylmethylammonium methosulfate or methyl-N,N-bis(acyloxyethyl)-N-(2-hydroxyethyl)ammonium methosulfate. When quaternized compounds of the formula (IV) which have unsaturated alkyl chains are used, preference is given to the acyl groups whose corresponding fatty acids have an iodine number between 5 and 80, preferably between 10 and 60 and especially between 15 and 45 and also a cis/trans isomer ratio (in % by weight) of greater than 30:70, preferably greater than 50:50 and especially greater than 70:30. Commercially available examples are the methylhydroxyalkyldi-alkoyloxyalkylammonium methosulfates marketed by Stepan under the Stepantex® brand or the Cognis products known as Dehyquart® or the Goldschmidt-Witco products known as Rewoquat®. Further preferred compounds include the diester quats of the formula (−) which are obtainable under the name Rewoquat® W 222 LM or CR 3099 and provide stability and color protection as well as softness. 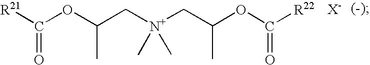
where R²¹ and R²² each independently represent an aliphatic radical having from 12 to 22 carbon atoms and 0, 1, 2 or 3 double bonds.

As well as the quaternary compounds described above, it is also possible to use other known compounds, for example, quaternary imidazolinium compounds of the formula (VI) 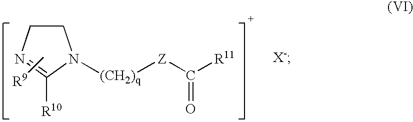
where R⁹ represents H or a saturated alkyl radical having from 1 to 4 carbon atoms, R¹⁰ and R¹¹ are each independently an aliphatic, saturated or unsaturated alkyl radical having from 12 to 18 carbon atoms, R¹⁰ may alternatively also represent O(CO)R²⁰ where R²⁰ is an aliphatic, saturated or unsaturated alkyl radical having from 12 to 18 carbon atoms, Z is an NH group or oxygen, X⁻ is an anion and q can assume integral values from 1 to 4.

Further suitable quaternary compounds are described by the formula (VII) 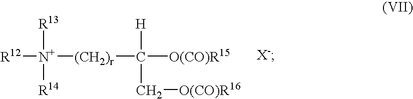
where R¹², R¹³ and R¹⁴ independently represent a C₁₋₄-alkyl, alkenyl or hydroxyalkyl group, R¹⁵ and R¹⁶ each independently represent a C₈₋₂₈-alkyl group and r is from 0 to 5.

As well as compounds of the formulae (III) to (VII) mentioned, it is also possible to use short-chain, water-soluble quaternary ammonium compounds, such as trihydroxyethylmethylammonium methosulfate or alkyltrimethylammonium chlorides, dialkyldimethylammonium chlorides and trialkylmethylammonium chlorides, for example, cetyltrimethylammonium chloride, stearyltrimethylammonium chloride, distearyldimethylammonium chloride, lauryldimethylammonium chloride, lauryldimethylbenzylammonium chloride and tricetylmethylammonium chloride.

Also suitable are protonated alkylamine compounds, which have a softening effect, and also the nonquaternized, protonated precursors of cationic emulsifiers.

Further cationic compounds usable in accordance with the invention are the quaternized protein hydrolyzates.

Suitable cationic polymers include the polyquaternium polymers, as in the CTFA Cosmetic Ingredient Dictionary (The Cosmetic, Toiletry and Fragrance, Inc. 1997), in particular the polyquaternium-6, polyquaternium-7, polyquaternium-10 polymers (Ucare Polymer IR 400; Amerchol), also referred to as merquats, polyquaternium-4 copolymers, such as graft copolymers with a cellulose backbone and quaternary ammonium groups which are bonded via allyldimethylammonium chloride, cationic cellulose derivatives, such as cationic guar, such as guar hydroxypropyltriammonium chloride, and similar quaternized guar derivatives (e.g. Cosmedia Guar, manufacturer: Cognis GmbH), cationic quaternary sugar derivatives (cationic alkyl polyglucosides), e.g. the commercial product Glucquat® 100, according to CTFA nomenclature a “Lauryl Methyl Gluceth-10 Hydroxypropyl Dimonium Chloride”, copolymers of PVP and dimethylaminomethacrylate, copolymers of vinylimidazole and vinylpyrrolidone, aminosilicone polymers and copolymers.

It is likewise possible to use polyquaternized polymers (e.g. Luviquat Care from BASF) and also cationic biopolymers based on chitin and derivatives thereof, for example, the polymer obtainable under the trade name Chitosan® (manufacturer: Cognis).

Likewise suitable are cationic silicone oils, such as, for example, the commercially available products Q2-7224 (manufacturer: Dow Corning; a stabilized trimethylsilylamodimethicone), Dow Corning 929 emulsion (comprising a hydroxyl-amino-modified silicone, which is also referred to as amodimethicone), SM-2059 (manufacturer: General Electric), SLM-55067 (manufacturer: Wacker) Abil®-Quat 3270 and 3272 (manufacturer: Goldschmidt-Rewo; diquaternary polydimethylsiloxanes, quaternium-80) and Siliconquat Rewoquat® SQ 1 (Tegopren® 6922, manufacturer: Goldschmidt-Rewo).

It is likewise possible to use compounds of the formula (VIII) 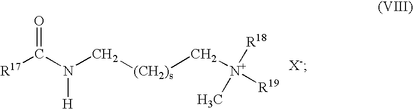
which may be alkylamidoamines in their nonquaternized or, as shown, their quaternized form. R¹⁷ may be an aliphatic alkyl radical having from 12 to 22 carbon atoms with 0, 1, 2 or 3 double bonds. s can assume values from 0 to 5. R¹⁸ and R¹⁹ are each independently H, C₁₋₄-alkyl or hydroxyalkyl. Preferred compounds are fatty acid amidoamines, such as the stearylamidopropyldimethylamine obtainable under the name Tego Amid® S18, or the 3-tallowamidopropyltrimethylammonium methosulfate obtainable under the name Stepantex® X 9124, which are characterized not only by a good conditioning effect, but also by color-transfer-inhibiting effect and in particular by their good biodegradability. Particular preference is given to alkylated quaternary ammonium compounds in which at least one alkyl chain is interrupted by an ester group and/or amido group, in particular N-methyl-N-(2-hydroxyethyl)-N,N-(ditallowacyloxyethyl)ammonium methosulfate and/or N-methyl-N-(2-hydroxyethyl)-N,N-(palmitoyloxyethyl)ammonium methosulfate.

Nonionic softeners are primarily polyoxyalkylene glycerol alkanoates, as described in British patent GB 2 202 244, polybutylenes, as described in British patent GB 2 199 855, long-chain fatty acids, as are described in Patent Application EP 0 013 780, ethoxylated fatty acid ethanolamides, as are described in Patent Application EP 0 043 547, alkyl polyglycosides, in particular sorbitan mono-, di- and triesters, as are described in EP 0 698 140, and fatty acid esters of polycarboxylic acids, as are described in German Patent DE 28 22 891.

In a preferred embodiment, inventive mild-action laundry detergents comprise cationic surfactants, preferably alkylated quaternary ammonium compounds in which at least one alkyl chain is interrupted by an ester group and/or amido group, in particular N-methyl-N-(2-hydroxyethyl)-N,N-(ditallowacyloxyethyl)ammonium methosulfate or N-methyl-N-(2-hydroxyethyl)-N,N-(dipalmitoylethyl)ammonium methosulfate.

In a further preferred embodiment, the inventive textile care compositions comprise softener components in an amount up to 35% by weight, preferably from 0.1% to 25% by weight, more preferably from 0.5% to 15% by weight and especially from 1 % to 10% by weight, based in each case on the overall composition.

In a particularly preferred embodiment of the invention, the inventive textile care compositions are in the form of mild-action laundry detergents or fabric softener compositions, comprising softeners, preferably cationic softeners, more preferably ester quats.

In addition to the aforementioned components, the inventive textile care compositions comprise pearlescents. Pearlescents endow textiles with an additional luster and therefore are preferentially used in the inventive mild-action laundry detergents.

Useful pearlescents include, for example,: alkylene glycol esters; fatty acid alkanolamides; partial glycerides; esters of polybasic, optionally hydroxy-substituted carboxylic acids with fatty alcohols having from 6 to 22 carbon atoms; fatty substances, for example, fatty alcohols, fatty ketones, fatty aldehydes, fatty ethers and fatty carbonates which in total have at least 24 carbon atoms; ring-opening products of olefin epoxides having from 12 to 22 carbon atoms with fatty alcohols having from 12 to 22 carbon atoms, fatty acids and/or polyols having from 2 to 15 carbon atoms and from 2 to 10 hydroxyl groups and also mixtures thereof.

Furthermore, liquid inventive textile care compositions may additionally comprise thickeners. The use of thickeners in the inventive textile care compositions which find use as liquid laundry detergents has been found to be particularly advantageous. The use of thickeners in particular in gel-form liquid laundry detergents has been found to increase consumer acceptance. The thickened consistency of the composition simplifies the application of the compositions directly to the stains to be treated. The kind of run-off familiar from thin liquid compositions is prevented as a result.

Polymers originating in nature which find use as thickeners are, for example, agar-agar, carrageenan, tragacanth, gum arabic, alginates, pectins, polyoses, guar flour, carob seed flour, starch, dextrins, gelatins and casein.

Modified natural substances originate primarily from the group of modified starches and celluloses, examples including carboxymethylcellulose and nonionic cellulose ethers such as hydroxyethylcellulose and hydroxypropylcellulose, and seed flour ether.

A large group of thickeners which is used widely in very diverse fields of application is that of the fully synthetic polymers, such as polyacrylic and polymethacrylic compounds, vinyl polymers, polycarboxylic acids, polyethers, polyimines, polyamides and polyurethanes.

Thickeners from said substance classes are commercially widely available and are obtainable, for example, under the trade names Acusol®-820 (methacrylic acid (stearyl alcohol-20-EO) ester-acrylic acid copolymer, 30% strength in water, Rohm & Haas), Dapral®-GT-282-S (alkyl polyglycol ether, Akzo), Deuterol®-Polymer-11 (dicarboxylic acid copolymer, Schöner GmbH), Deuteron®-XG (anionic heteropolysaccharide based on β-D-glucose, D-manose, D-glucuronic acid, Schöner GmbH), Deuteron®-XN (nonionogenic polysaccharide, Schöner GmbH), Dicrylan®-Verdicker-O (ethylene oxide adduct, 50% strength in water/isopropanol, Pfersse Chemie), EMA®-81 and EMA®-91 (ethylene-maleic anhydride copolymer, Monsanto), Verdicker-QR-1001 (polyurethane emulsion, 19-21% strength in water/diglycol ether, Rohm & Haas), Mirox®-AM (anionic acrylic acid-acrylic ester copolymer dispersion, 25% strength in water, Stockhausen), SER-AD-FX-1100 (hydrophobic urethane polymer, Servo Delden), Shellflo®-S (high molecular weight polysaccharide, stabilized with formaldehyde, Shell), and Shellflo®-XA (xanthan biopolymer, stabilized with formaldehyde, Shell).

A polymeric polysaccharide thickener to be used with preference is xanthan, a microbial anionic heteropolysaccharide which is produced by Xanthomonas campestris and some other species under aerobic conditions and has a molar mass of from 2 to 15 million g/mol. Xanthan is formed from a chain of β-1,4-bound glucose (cellulose) having side chains. The structure of the subgroups consists of glucose, mannose, glucuronic acid, acetate and pyruvate, the number of pyruvate units determining the viscosity of the xanthan.

Owing to their very substantial stability, it is particularly advantageous to use xanthans and modified xanthans.

In a preferred embodiment, the inventive textile care compositions comprise thickeners, preferably in amounts of up to 10% by weight, more preferably up to 5% by weight and especially from 0.1% to 1% by weight, based in each case on the overall composition.

Furthermore, the inventive textile care compositions may additionally comprise odor absorbers or dye transfer inhibitors. Especially for inventive textile care compositions which are in the form of mild-action, after-treatment and liquid laundry detergents, the use of dye transfer inhibitors has been found to be useful. For the deodorization of malodorous formulating constituents, for example, amine-containing components, but also for sustained deodorization of the washed textiles, the use of odor absorbers has been found to be very helpful.

In a preferred embodiment, the inventive textile care compositions optionally comprise from 0.1% by weight to 2% by weight and preferably from 0.2% by weight to 1% by weight of dye transfer inhibitor, which in a preferred embodiment of the invention is a polymer of vinylpyrrolidone, vinylimidazole, vinylpyridine N-oxide or a copolymer of these. Useful dye transfer inhibitors include not only the polyvinylpyrrolidones of molecular weights in the range from 15,000 to 50,000 which are known, for example, from European Patent Application EP 0 262 897 but also the polyvinylpyrrolidones having molecular weights above 1,000,000, especially from 1,500,000 to 4,000,000, which are known from International Patent Application WO 95/06098, the N-vinylimidazole-N-vinylpyrrolidone copolymers known from German Patent Applications DE 28 14 287 or DE 38 03 630 or International Patent Applications WO 94/10281, WO 94/26796, WO 95/03388 and WO 95/03382, the poly-vinyloxazolidones known from German Patent Application DE 28 14 329, the copolymers based on vinyl monomers and carboxamides that are known from European Patent Application EP 610 846, the polyesters and polyamides containing pyrrolidone groups that are known from International Patent Application WO 95/09194, the grafted polyamidoamines and polyethyleneimines known from International Patent Application WO 94/29422, the polymers with amide groups from secondary amines that are known from German Patent Application DE 43 28 254, the polyamine N-oxide polymers known from International Patent Application WO 94/02579 or European Patent Application EP 0 135 217, the polyvinyl alcohols known from European Patent Application EP 0 584 738, and the copolymers based on acrylamidoalkenylsulfonic acids that are known from European Patent Application EP 0 584 709. However, it is also possible to use enzymatic systems, comprising a peroxidase and hydrogen peroxide or a substance which, in water, affords hydrogen peroxide, as are known, for example, from International Patent Applications WO 92/18687 and WO 91/05839. The addition of a mediator compound for the peroxidase, for example, an acetosyringone known from International Patent Application WO 96/10079, a phenol derivative known from International Patent Application WO 96/12845, or a phenothiazine or phenoxazine known from International Patent Application WO 96/12846, is preferred in this case. Additionally, it is also possible to use the above-mentioned polymeric active dye transfer inhibitor substances. Polyvinylpyrrolidone for use in compositions of the invention preferably has an average molar mass in the range from 10,000 to 60,000, in particular in the range from 25,000 to 50,000. Among the copolymers, preference is given to those of vinylpyrrolidone and vinylimidazole in a molar ratio of 5:1 to 1:1 having an average molar mass in the range from 5,000 to 50,000, in particular from 10,000 to 20,000.

Preferred deodorizing substances in the context of the present invention include one or more metal salts of a branched or unbranched, saturated or unsaturated, mono- or polyhydroxylated fatty acid having 16 or more carbon atoms and/or a resin acid, except for the alkali metal salts, and also any desired mixtures thereof.

Ricinoleic acid is a particularly preferred branched or unbranched, saturated or unsaturated, singly or multiply hydroxylated fatty acid having 16 or more carbon atoms. Abietic acid is a particularly preferred resin acid.

Preferred metals are the transition metals and the lanthanoids, especially the transition metals of groups VIIIa, Ib and IIb of the periodic table and also lanthanum, cerium and neodymium, more preferably cobalt, nickel, copper and zinc and extremely preferably zinc. The cobalt, nickel and copper salts and the zinc salts are similarly effective, but zinc salts are preferable for toxicological reasons.

Deodorizing substances which are advantageous and therefore to be used with particular preference include one or more metal salts of ricinoleic acid and/or of abietic acid, preferably zinc ricinoleate and/or zinc abietate, especially zinc ricinoleate.

Useful further deodorizing substances in the context of the present invention have likewise been found to be cyclodextrins, and also mixtures of the aforementioned metal salts with cyclodextrins, preferably in a weight ratio of 1:10 to 10: 1, more preferably of 1:5 to 5:1 and especially of 1:3 to 3:1. The term “cyclodextrin” as used herein includes all known cyclodextrins, i.e. both unsubstituted cyclodextrins having 6 to 12 glucose units, especially alpha-, beta- and gamma-cyclodextrins, and their mixtures and/or their derivatives and/or their mixtures.

The inventive textile care compositions may additionally comprise further surfactants, for example, amphoteric surfactants.

The amphosurfactants (zwitterionic surfactants) which may be used in accordance with the invention include betaines, amine oxides, alkylamidoalkylamines, alkyl-substituted amino acids, acylated amino acids and biosurfactants, particular preference being given in the context of the inventive teaching to the betaines.

Suitable betaines are the alkylbetaines, the alkylamidobetaines, the imidazoliniumbetaines, the sulfobetaines (INCI Sultaines), and the phosphobetaines and preferably satisfy the formula IX
R¹—[CO—X—(CH₂)ₙ]ₓ—N⁺(R²)(R³)—(CH₂)ₘ—[CH(OH)—CH₂]_{y}—Y⁻ (IX)
in which R¹ is a saturated or unsaturated C₆₋₂₂-alkyl radical, preferably C₈₋₁₈-alkyl radical, in particular a saturated C₁₀₋₁₆-alkyl radical, for example, a saturated C₁₂₋₁₄-alkyl radical, X is NH, NR⁴ with the C₁₋₄-alkyl radical R⁴, O or S, n is from 1 to 10, preferably 2 to 5, in particular 3, x is 0 or 1, preferably 1, R², R³ are each independently a C₁₋₄-alkyl radical, optionally hydroxy-substituted, for example, a hydroxyethyl radical, but in particular a methyl radical, m is from 1 to 4, in particular 1, 2 or 3, y is 0 or 1, and Y is COO, SO₃, OPO(OR⁵)O or P(O)(OR⁵)O, where R⁵ is a hydrogen atom or a C₁₋₄-alkyl radical.

Preferred amphosurfactants are the alkylbetaines of the formula (IXa), the alkylamidobetaines of the formula (IXb), the sulfobetaines of the formula (IXc) and the amidosulfobetaines of the formula (IXd)
R¹—N⁺(CH₃)₂—CH₂COO⁻ (IXa)
R¹—CO—NH—(CH₂)₃—N⁺(CH₃)₂—CH₂COO⁻ (IXb)
R¹—N⁺(CH₃)₂—CH₂CH(OH )CH₂SO₃⁻ (IXc)
R¹—CO—NH—(CH₂)₃—N⁺(CH₃)₂—CH₂CH(OH)CH₂SO₃⁻ (IXd)
in which R¹ has the same meaning as in formula IX.

Particularly preferred amphoteric surfactants are the carbobetaines, in particular the carbobetaines of the formula (IXa) and (IXb), most preferably the alkylamidobetaines of the formula (IXb).

Examples of suitable betaines and sulfobetaines are the following compounds named according to INCI: Almondamidopropyl Betaine, Apricotamidopropyl Betaine, Avocadamidopropyl Betaine, Babassuamidopropyl Betaine, Behenamidopropyl Betaine, Behenyl Betaine, Betaine, Canolamidopropyl Betaine, Capryl/Capramidopropyl Betaine, Carnitine, Cetyl Betaine, Cocamidoethyl Betaine, Cocamidopropyl Betaine, Cocamidopropyl Hydroxysultaine, Coco-Betaine, Coco-Hydroxysultaine, Coco/Oleamidopropyl Betaine, Coco-Sultaine, Decyl Betaine, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl PG-Betaine, Erucamidopropyl Hydroxysultaine, Hydrogenated Tallow Betaine, Isostearamidopropyl Betaine, Lauramidopropyl Betaine, Lauryl Betaine, Lauryl Hydroxysultaine, Lauryl Sultaine, Milkamidopropyl Betaine, Minkamidopropyl Betaine, Myristamidopropyl Betaine, Myristyl Betaine, Oleamidopropyl Betaine, Oleamidopropyl Hydroxysultaine, Oleyl Betaine, Olivamidopropyl Betaine, Palmamidopropyl Betaine, Palmitamidopropyl Betaine, Palmitoyl Carnitine, Palm Kernelamiodopropyl Betaine, Polytetrafluoroethylene Acetoxypropyl Betaine, Ricinoleamidopropyl Betaine, Sesamidopropyl Betaine, Soyamidopropyl Betaine, Stearamidopropyl Betaine, Stearyl Betaine, Tallowamidopropyl Betaine, Tallowamidopropyl Hydroxysultaine, Tallow Betaine, Tallow Dihydroxyethyl Betaine, Undecylenamidopropyl Betaine and Wheat Germamidopropyl Betaine.

The amine oxides suitable in accordance with the invention include alkylamine oxides, in particular alkyldimethylamine oxides, alkylamidoamine oxides and alkoxy-alkylamine oxides. Preferred amine oxides satisfy formula XI or XII,
R⁶R⁷R⁸N⁺—O⁻ (XI)
R⁶—[CO—NH—(CH₂)_{w}]_{z}—N⁺(R⁷)(R⁸)—O— (XII)
in which R⁶ is a saturated or unsaturated C₆₋₂₂-alkyl radical, preferably C₈₋₁₈-alkyl radical, in particular a saturated C₁₀₋₁₆-alkyl radical, for example, a saturated C₁₂₋₁₄-alkyl radical, which is bonded to the nitrogen atom N in the alkylamidoamine oxides via a carbonylamidoalkylene group —CO—NH—(CH₂)_{z}, and in the alkoxyalkylamine oxides via an oxaalkylene group —O—(CH₂)_{z}, where z is in each case from 1 to 10, preferably 2 to 5, in particular 3, R⁷, R⁸ are each independently a C₁₋₄-alkyl radical, optionally hydroxy-substituted, for example, a hydroxyethyl radical, in particular a methyl radical.

Examples of suitable amine oxides are the following compounds named in accordance with INCI: Almondamidopropylamine Oxide, Babassuamidopropylamine Oxide, Behenamine Oxide, Cocamidopropyl Amine Oxide, Cocamidopropylamine Oxide, Cocamine Oxide, Coco-Morpholine Oxide, Decylamine Oxide, Decyltetradecylamine Oxide, Diaminopyrimidine Oxide, Dihydroxyethyl C8-10 Alkoxypropylamine Oxide, Dihydroxyethyl C9-11 Alkoxypropylamine Oxide, Dihydroxyethyl C12-15 Alkoxypropylamine Oxide, Dihydroxyethyl Cocamine Oxide, Dihydroxyethyl Lauramine Oxide, Dihydroxyethyl Stearamine Oxide, Dihydroxyethyl Tallowamine Oxide, Hydrogenated Palm Kernel Amine Oxide, Hydrogenated Tallowamine Oxide, Hydroxyethyl Hydroxypropyl C12-15 Alkoxypropylamine Oxide, Isostearamidopropylamine Oxide, Isostearamidopropyl Morpholine Oxide, Lauramidopropylamine Oxide, Lauramine Oxide, Methyl Morpholine Oxide, Milkamidopropyl Amine Oxide, Minkamidopropylamine Oxide, Myristamido-propylamine Oxide, Myristamine Oxide, Myristyl/Cetyl Amine Oxide, Oleamidopropylamine Oxide, Oleamine Oxide, Olivamidopropylamine Oxide, Palmitamidopropylamine Oxide, Palmitamine Oxide, PEG-3 Lauramine Oxide, Potassium Dihydroxyethyl Cocamine Oxide Phosphate, Potassium Trisphosphonomethylamine Oxide, Sesamidopropylamine Oxide, Soyamidopropylamine Oxide, Stearamidopropylamine Oxide, Stearamine Oxide, Tallow-amidopropylamine Oxide, Tallowamine Oxide, Undecylenamidopropylamine Oxide and Wheat Germamidopropylamine Oxide.

The alkylamidoalkylamines (INCI Alkylamido Alkylamines) are amphoteric surfactants of the formula (XIII)
R⁹—CO—NR¹⁰—(CH₂)ᵢ—N(R¹¹)—(CH₂CH₂O)ⱼ—(CH₂)ₖ—[CH(OH)]ₗ—CH₂—Z—OM (XIII)
in which R⁹ is a saturated or unsaturated C₆₋₂₂-alkyl radical, preferably C₈₋₁₈-alkyl radical, in particular a saturated C₁₀₋₁₆-alkyl radical, for example, a saturated C₁₂₋₁₄-alkyl radical, R¹⁰ is hydrogen or a C₁₋₄-alkyl radical, preferably H, i is from 1 to 10, preferably 2 to 5, in particular 2 or 3, R¹¹ is hydrogen or CH₂COOM, j is from 1 to 4, preferably 1 or 2, in particular 1, k is from 0 to 4, preferably 0 or 1, I is 0 or 1, where k=1 when I=1, Z is CO, SO₂, OPO(OR¹²) or P(O)(OR¹²), where R¹² is a C₁₋₄-alkyl radical or is M, and M is hydrogen, an alkali metal, an alkaline earth metal or a protonated alkanolamine, e.g. protonated mono-, di- or triethanolamine.
Preferred representatives satisfy the formulae XIIIa to XIIId
R⁹—CO—NH—(CH₂)₂—N(R¹¹)—CH₂CH₂O—CH₂—COOM (XIIIa)
R⁹—CO—NH—(CH₂)₂—N(R¹¹)—CH₂CH₂O—CH₂CH₂—COOM (XIIIb)
R⁹—CO—NH—(CH₂)₂—N(R¹¹)—CH₂CH₂O—CH₂CH(OH)CH₂—SO₃M (XIIIc)
R⁹—CO—NH—(CH₂)₂—N(R¹¹)—CH₂CH₂O—CH₂CH(OH)CH₂—OPO₃HM (XIIId)
in which R⁹, R¹¹ and M have the same meanings as in formula (XIII). Examples of alkylamidoalkylamines are the following compounds named in accordance with INCI: Cocoamphodipropionic Acid, Cocobetainamido Amphopropionate, DEA-Cocoamphodipropionate, Disodium Caproamphodiacetate, Disodium Caproamphodipropionate, Disodium Capryloamphodiacetate, Disodium Capryloamphodi-propionate, Disodium Cocoamphocarboxyethylhydroxypropylsulfonate, Disodium Cocoamphodiacetate, Disodium Cocoamphodipropionate, Disodium Isostearoampho-diacetate, Disodium Isostearoamphodipropionate, Disodium Laureth-5 Carboxyamphodiacetate, Disodium Lauroamphodiacetate, Disodium Lauroamphodipropionate, Disodium Oleoamphodipropionate, Disodium PPG-2-Isodeceth-7 Carboxyamphodiacetate, Disodium Stearoamphodiacetate, Disodium Tallowamphodiacetate, Disodium Wheatgermamphodiacetate, Lauroamphodipropionic Acid, Quaternium-85, Sodium Caproamphoacetate, Sodium Caproamphohydroxypropylsulfonate, Sodium Caproamphopropionate, Sodium Capryloamphoacetate, Sodium Capryloamphohydroxypropylsulfonate, Sodium Capryloamphopropionate, Sodium Cocoamphoacetate, Sodium Cocoamphohydroxypropylsulfonate, Sodium Cocoampho-propionate, Sodium Cornamphopropionate, Sodium Isostearoamphoacetate, Sodium Isostearoamphopropionate, Sodium Lauroamphoacetate, Sodium Lauroamphohydroxy-propylsulfonate, Sodium Lauroampho PG-Acetate Phosphate, Sodium Lauroamphopropionate, Sodium Myristoamphoacetate, Sodium Oleoamphoacetate, Sodium Oleoamphohydroxypropylsulfonate, Sodium Oleoamphopropionate, Sodium Ricinoleoamphoacetate, Sodium Stearoamphoacetate, Sodium Stearoamphohydroxypropyl-sulfonate, Sodium Stearoamphopropionate, Sodium Tallamphopropionate, Sodium Tallowamphoacetate, Sodium Undecylenoamphoacetate, Sodium Undecylenoampho-propionate, Sodium Wheat Germamphoacetate and Trisodium Lauroampho PG-Acetate Chloride Phosphate.

Alkyl-substituted amino acids (INCI Alkyl-Substituted Amino Acids) preferred in accordance with the invention are monoalkyl-substituted amino acids of the formula (XIV)
R¹³—NH—CH(R¹⁴)—(CH₂)ᵤ—COOM′ (XIV)
in which R¹³ is a saturated or unsaturated C₆₋₂₂-alkyl radical, preferably C₈₋₁₈-alkyl radical, in particular a saturated C₁₀₋₁₆-alkyl radical, for example, a saturated C₁₂₋₁₄-alkyl radical, R¹⁴ is hydrogen or a C₁₋₄-alkyl radical, preferably H, u is from 0 to 4, preferably 0 or 1, in particular 1, and M′ is hydrogen, an alkali metal, an alkaline earth metal or a protonated alkanolamine, e.g. protonated mono-, di- or triethanolamine, alkyl-substituted imino acids of the formula (XV)
R¹⁵—N—[(CH₂)ᵥ—COOM⁻]₂ (XV)
in which R¹⁵ is a saturated or unsaturated C₆₋₂₂-alkyl radical, preferably C₈₋₁₈-alkyl radical, in particular a saturated C₁₀₋₁₆-alkyl radical, for example, a saturated C₁₂₋₁₄-alkyl radical, v is from 1 to 5, preferably 2 or 3, in particular 2, and M″ is hydrogen, an alkali metal, an alkaline earth metal or a protonated alkanolamine, e.g. protonated mono-, di- or triethanolamine, where M″ in the two carboxyl groups can have the same meaning or two different meanings, e.g. hydrogen and sodium or sodium and sodium, and mono- and dialkyl-substituted natural amino acids of the formula (XVI)
R¹⁶—N(R¹⁷)—CH(R¹⁸)—COOM′″ (XVI)
in which R¹⁶ is a saturated or unsaturated C₆₋₂₂-alkyl radical, preferably C₈₋₁₈-alkyl radical, in particular a saturated C₁₀₋₁₆-alkyl radical, for example, a saturated C₁₂₋₁₄-alkyl radical, R¹⁷ is hydrogen or a C₁₋₄-alkyl radical, optionally hydroxy- or amino-substituted, e.g. a methyl, ethyl, hydroxyethyl or aminopropyl radical, R¹⁸ is the radical of one of the 20 natural α-amino acids H₂NCH(R¹⁸)COOH, and M″ is hydrogen, an alkali metal, an alkaline earth metal or a protonated alkanolamine, e.g. protonated mono-, di- or triethanolamine.

Particularly preferred alkyl-substituted amino acids are the aminopropionates according to formula (XIVa)
R¹³—NH—CH₂CH₂COOM′ (XIVa)
in which R¹³ and M′ have the same meanings as in formula (XIV).

Examples of alkyl-substituted amino acids are the following compounds named in accordance with INCI: Aminopropyl Laurylglutamine, Cocaminobutyric Acid, Cocaminopropionic Acid, DEA-Lauraminopropionate, Disodium Cocaminopropyl Iminodiacetate, Disodium Dicarboxyethyl Cocopropylenediamine, Disodium Laurimino-dipropionate, Disodium Steariminodipropionate, Disodium Tallowiminodipropionate, Lauraminopropionic Acid, Lauryl Aminopropylglycine, Lauryl Diethylenediaminoglycine, Myristaminopropionic Acid, Sodium C12-15 Alkoxypropyl Iminodipropionate, Sodium Cocaminopropionate, Sodium Lauraminopropionate, Sodium Lauriminodipropionate, Sodium Lauroyl Methylaminopropionate, TEA-Lauraminopropionate and TEA-Myrist-aminopropionate.

Acylated amino acids are amino acids, in particular the 20 natural α-amino acids, which bear the acyl radical R¹⁹CO of a saturated or unsaturated fatty acid R¹⁹COOH on the amino nitrogen atom, where R¹⁹ is a saturated or unsaturated C₆₋₂₂-alkyl radical, preferably C₈₋₁₈-alkyl radical, in particular a saturated C₁₀₋₁₆-alkyl radical, for example, a saturated C₁₂₋₁₄-alkyl radical. The acylated amino acids can also be used as alkali metal salt, alkaline earth metal salt or alkanolammonium salt, e.g. mono-, di- or triethanolammonium salt. Examples of acylated amino acids are the acyl derivatives grouped together according to INCI under Amino Acids, e.g. Sodium Cocoyl Glutamate, Lauroyl Glutamic Acid, Capryloyl Glycine or Myristoyl Methylalanine.

In a preferred embodiment, the total surfactant content of the inventive textile care compositions, without the amount of fatty acid soap, is below 55% by weight, preferably below 50% by weight, more preferably between 12% and 48% by weight, based in each case on the overall composition.

The inventive textile care compositions may additionally comprise further laundry detergent additives, for example, from the group of builders, bleaches, bleach activators, electrolytes, pH standardizers, fragrances, perfume carriers, fluorescers, dyes, foam inhibitors, graying inhibitors, antimicrobial actives, germicides, fungicides, antioxidants, antistats, ironing aids, UV absorbers, optical brighteners, antiredeposition agents, viscosity regulators, shrink preventatives, corrosion inhibitors, preservatives, repellants and impregnants.

The inventive compositions may comprise builders. It is possible for any builder used customarily in washing and cleaning compositions to be incorporated into the inventive compositions, especially zeolites, silicates, carbonates, organic cobuilders and—provided that there are no ecological prejudices against their use—phosphates.

Useful crystalline, sheet-shaped sodium silicates have the general formula NaMSiₓO₂ₓ₊₁.yH₂O where M is sodium or hydrogen, x is from 1.9 to 4, y is from 0 to 20 and x is preferably 2, 3 or 4. Such crystalline sheet silicates are described, for example, in European Patent Application EP-A-0 164 514. Preferred crystalline sheet silicates of the stated formula are those in which M is sodium and x is 2 or 3. In particular, not only β- but also δ-sodium disilicates Na₂Si₂O₅.yH₂O are preferred, β-sodium disilicate being obtainable, for example, by the process described in International Patent Application WO-A-91/08171.

It is also possible to use amorphous sodium silicates having an Na₂O:SiO₂ modulus of from 1:2 to 1:3.3, preferably from 1:2 to 1:2.8 and in particular from 1:2 to 1:2.6, which have retarded dissolution and secondary washing properties. The retarded dissolution relative to conventional amorphous sodium silicates may have been brought about in a variety of ways, for example, by surface treatment, compounding, compacting or by overdrying. For the purposes of this invention the term “amorphous” is also understood to mean “X-ray-amorphous”. This means that, in X-ray diffraction experiments, the silicates do not yield the sharp X-ray reflections typical of crystalline substances, but instead yield at best one or more maxima of the scattered X-radiation, having a width of several degree units of the diffraction angle. However, even particularly good builder properties may result if the silicate particles in electron diffraction experiments yield vague or even sharp diffraction maxima. This is to be interpreted such that the products have microcrystalline regions with a size of from 10 to several hundred nm, values up to a maximum of 50 nm and in particular up to a maximum of 20 nm being preferred. Such so-called X-ray amorphous silicates likewise have retarded dissolution compared with conventional waterglasses and are described in German Patent Application DE-A-44 00 024. Particular preference is given to compacted amorphous silicates, compounded amorphous silicates and overdried X-ray-amorphous silicates.

The finely crystalline synthetic zeolite used, containing bound water, is preferably zeolite A and/or P. Zeolite P is particularly preferably Zeolite MAP® (commercial product from Crosfield). Also suitable, however, are zeolite X, and mixtures of A, X and/or P. A cocrystal of zeolite X and zeolite A (about 80% by weight of zeolite X), which is sold by CONDEA Augusta S.p.A. under the trade name VEGOBOND AX® and can be described by the formula
nNa₂O.(1-n)K₂O.Al₂O₃.(2-2.5)SiO₂.(3.5-5.5)H₂O
is, for example, also commercially available and preferred for the purposes of the present invention. Useful zeolites have a mean particle size of less than 10 μm (volume distribution; method of measurement: Coulter Counter) and have a bound-water content which is preferably in the range from 18% to 22% by weight and especially in the range from 20% to 22% by weight. The zeolites can also be used in the form of overdried zeolites having lower water contents and then, by virtue of their hygroscopicity, are suitable for removing unwanted trace residues of free water.

It will be appreciated that the well-known phosphates can likewise be used as builder substances, unless such a use is to be avoided for ecological reasons. Suitable phosphates include in particular the sodium salts of the orthophosphates, of the pyrophosphates and especially of the tripolyphosphates.

Suitable builders are also polymeric polycarboxylates; these are, for example, the alkali metal salts of polyacrylic acid or of polymethacrylic acid, for example, those having a relative molecular mass of from 500 to 70,000 g/mol.

The molar masses reported here for polymeric polycarboxylates are weight-average molar masses Mw of the particular acid form, which can in principle be determined by means of gel permeation chromatography (GPC) using a UV detector. The measurement is effected against an external standard, preferably against a polyacrylic acid standard, which, owing to its structural relationship with the polymers investigated, provides realistic molar mass values. These data often deviate significantly from the molar mass data for which polystyrenesulfonic acids are used as the standard, the molar masses measured against polystyrenesulfonic acids generally being significantly higher. Suitable polymers are in particular polyacrylates which preferably have a molecular mass of from 2,000 to 20,000 g/mol. Owing to their superior solubility, the short-chain polyacrylates which have molar masses of from 2,000 to 10,000 g/mol and more preferably of from 3,000 to 5,000 g/mol may in turn be preferred from this group.

Suitable polymers may also include substances which consist partly or fully of units formed from vinyl alcohol or derivatives thereof.

Also suitable are copolymeric polycarboxylates, especially those of acrylic acid with methacrylic acid and of acrylic acid or methacrylic acid with maleic acid. Particularly suitable copolymers have been found to be those of acrylic acid with maleic acid which contain from 50 to 90% by weight of acrylic acid and from 50 to 10% by weight of maleic acid. Their relative molecular mass, based on free acids, is generally from 2,000 to 70,000 g/mol, preferably from 20,000 to 50,000 g/mol and in particular from 30,000 to 40,000 g/mol. The (co)polymeric polycarboxylates may be used either as an aqueous solution or preferably as a powder.

To improve the water solubility, the polymers may also contain allylsulfonic acids, for example, allyloxybenzenesulfonic acid and methallylsulfonic acid, disclosed in patent EP-B-0 727 448, as monomers.

Further preferred copolymers are those which are described in German Patent Applications DE-A-43 03 320 and DE-A-44 17 734 and which have, respectively, as monomers, preferably acrolein and acrylic acid/acrylic acid salts, and acrolein and vinyl acetate.

As further preferred builder substances, mention should likewise be made of polymeric aminodicarboxylic acids, salts thereof or precursor substances thereof. Particular preference is given to polyaspartic acids or salts and derivatives thereof, which are disclosed by German Patent Application DE-A-195 40 086 to have not only cobuilder properties but also bleach-stabilizing action. Also suitable are polyvinylpyrrolidones, polyamine derivatives such as quaternized and/or ethoxylated hexamethylenediamines.

Further suitable builder substances are polyacetals which can be obtained by reacting dialdehydes with polyolcarboxylic acids which have from 5 to 7 carbon atoms and at least 3 hydroxyl groups, for example, as described in European Patent Application EP-A-0 280 223. Preferred polyacetals are obtained from dialdehydes such as glyoxal, glutaraldehyde, terephthalaldehyde and mixtures thereof, and from polyolcarboxylic acids such as gluconic acid and/or glucoheptonic acid.

Suitable organic builder substances are also dextrins, for example, oligomers or polymers of carbohydrates which can be obtained by partial hydrolysis of starches. The hydrolysis can be carried out by customary processes, for example, acid- or enzyme-catalyzed processes. The hydrolysis products preferably have mean molar masses in the range from 400 to 500,000 g/mol. Preference is given to a polysaccharide having a dextrose equivalent (DE) in the range from 0.5 to 40, in particular from 2 to 30, DE being a useful measure for the reducing action of a polysaccharide in comparison to dextrose, which has a DE of 100. Useful polysaccharides are both maltodextrins having a DE between 3 and 20 and dry glucose syrups having a DE between 20 and 37, and so-called yellow dextrins and white dextrins having higher molar masses in the range from 2,000 to 30,000 g/mol. The oxidized derivatives of such dextrins are their reaction products with oxidizing agents which are capable of oxidizing at least one alcohol function of the saccharide ring to the carboxylic acid function. Such oxidized dextrins and processes for their preparation are known, for example, from European patent applications EP-A-0 232 202, EP-A-0 427 349, EP-A-0 472 042 and EP-A-0 542 496, and also International Patent Applications WO-A-92/18542, WO-A-93/08251, WO-A-93/161 10, WO-A-94/28030, WO-A-95/07303, WO-A-95/12619 and WO-A-95/20608. Likewise suitable is an oxidized oligosaccharide according to German Patent Application DE-A-196 00 018. A product oxidized on C₆ of the saccharide ring may be particularly advantageous.

Oxydisuccinates and other derivatives of disuccinates, preferably ethylenediamine disuccinates, are further suitable cobuilders. Ethylenediamine N,N′-disuccinate (EDDS), whose synthesis is described, for example, in U.S. Pat. No. 3,158,615, is preferably used in the form of its sodium or magnesium salts. In addition, preference is also given in this context to glyceryl disuccinates and glyceryl trisuccinates, as described, for example, in the U.S. Pat. No. 4,524,009, U.S. Pat. No. 4,639,325, in European Patent Application EP-A-0 150 930 and Japanese Patent Application JP-A-93/339896. Suitable use amounts in zeolitic and/or silicatic formulations are from about 3 to 15% by weight.

Further useful organic cobuilders are, for example, acetylated hydroxycarboxylic acids and salts thereof, which may optionally also be present in lactone form and which contain at least 4 carbon atoms and at least one hydroxyl group, and a maximum of two acid groups. Such cobuilders are described, for example, in International Patent Application WO 95/20029.

The inventive compositions may optionally comprise builders in amounts of from 1% to 60% by weight, preferably from 20% to 50% by weight.

The compositions of the present invention, may comprise bleaches.

Among the compounds which serve as bleaches in that they supply H₂O₂ in water, sodium percarbonate, sodium perborate tetrahydrate and sodium perborate monohydrate are of particular importance. Useful bleaches further include, for example, peroxypyrophosphates, citrate perhydrates and also H₂O₂-supplying peracidic salts or peracids, such as persulfates and persulfuric acid. It is also possible to use urea peroxohydrate, i.e. percarbamide, which is described by the formula H₂N—CO—NH₂.H₂O₂. Especially when the compositions are used for cleaning hard surfaces, for example, in machine dishwashing, they can if desired also include bleaches from the group of organic bleaches, although their use is in principle also possible in compositions for textile laundry. Typical organic bleaches are the diacyl peroxides, for example, dibenzoyl peroxide. Typical organic bleaches further include the peroxy acids, examples being in particular alkylperoxy acids and arylperoxy acids. Preferred representatives are peroxybenzoic acid and its ring-substituted derivatives, such as alkylperoxybenzoic acids, but also peroxy-α-naphthoic acid and magnesium monoperphthalate, aliphatic or substitutedly aliphatic peroxy acids, such as peroxylauric acid, peroxystearic acid, ε-phthalimidoperoxycaproic acid (phthalimidoperoxyhexanoic acid, PAP), o-carboxybenzamidoperoxycaproic acid, N-nonenylamidoperadipic acid and N-nonenylamidopersuccinates, and aliphatic and araliphatic peroxydicarboxylic acids, such as 1,12-diperoxycarboxylic acid, 1,9-diperoxyazelaic acid, diperoxysebacic acid, diperoxybrassylic acid, diperoxyphthalic acids, 2-decyldiperoxybutane-1,4-diacid, N,N-terephthaloyldi(6-aminopercaproic acid). More preferably, the compositions of the present invention may comprise phthalimidoperoxyhexanoic acid (PAP). The bleaches may be coated to protect them from premature decomposition.

The compositions of the present invention may comprise bleach activators.

The bleach activators used may be compounds which, under perhydrolysis conditions, give rise to aliphatic peroxo carboxylic acids having preferably from 1 to 10 carbon atoms and especially from 2 to 4 carbon atoms, and/or in some cases substituted perbenzoic acid. Suitable substances are those which bear O— and/or N-acyl groups of the stated number of carbon atoms and/or substituted or unsubstituted benzoyl groups. Preference is given to polyacylated alkylenediamines, especially tetraacetylethylenediamine (TAED), acylated triazine derivatives, especially 1,5-diacetyl-2,4-dioxohexahydro-1,3,5-tri-azine (DADHT), acylated glycolurils, especially tetraacetylglycoluril (TAGU), N-acylimides, especially N-nonanoylsuccinimide (NOSI), acylated phenolsulfonates, especially n-nonanoyl- or isononanoyloxybenzenesulfonate (n- and iso-NOBS respectively), carboxylic anhydrides, especially phthalic anhydride, acylated polyhydric alcohols, especially triacetin, triethyl acetylcitrate (TEAC), ethylene glycol diacetate, 2,5-diacetoxy-2,5-dihydrofuran and the enol esters known from German patent applications DE 196 16 693 and DE 196 16 767 and also acetylated sorbitol and mannitol, or their mixtures (SORMAN) described in European Patent Application EP 0 525 239, acylated sugar derivatives, especially pentaacetylglucose (PAG), pentaacetylfructose, tetraacetylxylose and octaacetyllactose and also acylated, optionally N-alkylated glucamine and gluconolactone, and/or N-acylated lactams, for example, N-benzoylcaprolactam, which are each known from International Patent Applications WO 94/27970, WO 94/28102, WO 94/28103, WO 95/00626, WO 95/14759 and WO 95/17498. The hydrophilically substituted acylacetals known from German Patent Application DE 196 16 769 and the acyllactams described in German Patent Application DE 196 16 770 and also International Patent Application WO 95/14075 are likewise preferred. It is also possible to use the combinations of conventional bleach activators described in German Patent Application DE 44 43 177. A further class of preferred bleach activators is that of the cationic acetonitrile derivatives RR′R″N⁺CH₂CN known, for example, from the European and International Patent Applications EP 0 303 520, EP 0 458 396, EP 0 464 880 or WO 96/40661, which, under perhydrolysis conditions, give rise to corresponding perimido acids.

The compositions of the present invention may comprise electrolytes.

A large number of very different salts can be used as electrolytes from the group of the inorganic salts. Preferred cations are the alkali metals and alkaline earth metals; preferred anions are the halides and sulfates. From the point of view of manufacturing convenience, the use of NaCl or MgCl₂ in the compositions of the present invention is preferred. The fraction of electrolytes in the compositions of the present invention is typically in the range from 0.5% to 5% by weight.

The compositions of the present invention may comprise pH standardizers.

To adjust the pH of the compositions according to the invention into the desired range, the use of pH standardizers may be indicated. Useful pH standardizers include all known acids and alkalis unless their use is ruled out by performance or ecological concerns or by consumer protection concerns. Typically, the amount of these standardizers does not exceed 2% by weight of the total formulation.

The compositions of the present invention may comprise dyes and fragrances.

Dyes and fragrances are added to the compositions of the invention in order to enhance the esthetic appeal of the products and to provide the consumer with not only the washing or cleaning performance but also a visually and sensorially “typical and unmistakable” product. As perfume oils and/or fragrances it is possible to use individual odorant compounds, examples being the synthetic products of the ester, ether, aldehyde, ketone, alcohol and hydrocarbon types. Odorant compounds of the ester type are, for example, benzyl acetate, phenoxyethyl isobutyrate, p-tert-butylcyclohexyl acetate, linalyl acetate, dimethylbenzylcarbinyl acetate, phenylethyl acetate, linalyl benzoate, benzyl formate, ethyl methylphenylglycinate, allyl cyclohexylpropionate, styrallyl propionate and benzyl salicylate. The ethers include, for example, benzyl ethyl ether; the aldehydes include, for example, the linear alkanals having 8-18 carbon atoms, citral, citronellal, citronellyloxyacetaldehyde, cyclamenaldehyde, hydroxycitronellal, lilial and bourgeonal; the ketones include, for example, the ionones, α-isomethylionone and methyl cedryl ketone; the alcohols include anethole, citronellol, eugenol, geraniol, linalool, phenylethyl alcohol and terpineol; the hydrocarbons include primarily the terpenes such as limonene and pinene. Preference, however, is given to using mixtures of different odorants, which together produce an appealing fragrance note. Such perfume oils may also contain natural odorant mixtures, as are obtainable from plant sources, examples being pine oil, citrus oil, jasmine oil, patchouli oil, rose oil or ylang-ylang oil. Likewise suitable are muscatel, sage oil, camomile oil, clove oil, balm oil, mint oil, cinnamon leaf oil, lime blossom oil, juniper oil, vetiver oil, olibanum oil, galbanum oil and labdanum oil, and also orange blossom oil, neroli oil, orange peel oil and sandalwood oil.

The inventive compositions may comprise UV absorbers which become attached to the treated textiles and improve the light stability of the fibers and/or the light stability of the other formula components. UV absorbers should be understood to mean organic substances (light protection filters) which are capable of absorbing ultraviolet rays and re-emitting the absorbed energy in the form of longer-wave radiation, e.g. heat. Examples of compounds which have these desired properties are the compounds active through non-radiative deactivation and derivatives of benzophenone with substituents in the 2- and/or 4-position. Further, substituted benzotriazoles, such as, for example, the water-soluble benzenesulfonic acid-3-(2H-benzotriazol-2-yl )-4-hydroxy-5-(methylpropyl) monosodium salt (Cibafast® H), acrylates phenyl-substituted in the 3-position (cinnamic acid derivatives), optionally with cyano groups in the 2-position, salicylates, organic nickel complexes and natural substances such as umbelliferone and the endogenous urocanic acid are suitable. Of particular importance are biphenyl derivatives and, above all, stilbene derivatives, as are described, for example, in EP 0728749 A and are commercially available from Ciba as Tinosorb® FD or Tinosorb® FR. As UV-B absorbers, mention can be made of 3-benzylidenecamphor and 3-benzylidenenorcamphor and derivatives thereof, e.g. 3-(4-methylbenzylidene)camphor, as described in EP 0693471 B1, 4-aminobenzoic acid derivatives, preferably 2-ethylhexyl 4-(dimethylamino)benzoate, 2-octyl 4-(dimethylamino)benzoate and amyl 4-(dimethylamino)benzoate, esters of cinnamic acid, preferably 2-ethylhexyl 4-methoxycinnamate, propyl 4-methoxycinnamate, isoamyl 4-methoxycinnamate and 2-ethylhexyl 2-cyano-3,3-phenylcinnamate (Octocrylene), esters of salicylic acid, preferably 2-ethylhexyl salicylate, 4-isopropylbenzyl salicylate and homomenthyl salicylate, derivatives of benzophenone, preferably 2-hydroxy-4-methoxybenzophenone, 2-hydroxy-4-methoxy-4′-methylbenzophenone and 2,2′-dihydroxy-4-methoxybenzophenone, esters of benzalmalonic acid, preferably di-2-ethylhexyl 4-methoxybenzmalonate, triazine derivatives, for example, 2,4,6-trianilino-(p-carbo-2′-ethyl-1′-hexyloxy)-1,3,5-triazine and Octyl Triazone, as described in EP 0818450 A1 or Dioctyl Butamido Triazone (Uvasorb® HEB), propane-1,3-diones such as, for example, 1-(4-tert-butylphenyl)-3-(4′-methoxyphenyl)propane-1,3-dione and ketotricyclo-(5.2. 1.0)decane derivatives, as described in EP 0694521 B1. Also suitable are 2-phenylbenzimidazole-5-sulfonic acid and alkali metal, alkaline earth metal, ammonium, alkylammonium, alkanol-ammonium and glucammonium salts thereof, sulfonic acid derivatives of benzophenones, preferably 2-hydroxy-4-methoxybenzophenone-5-sulfonic acid and salts thereof, sulfonic acid derivatives of 3-benzylidenecamphor, such as, for example, 4-(2-oxo-3-bornylidenemethyl)benzenesulfonic acid and 2-methyl-5-(2-oxo-3-bornylidene)sulfonic acid and salts thereof.

Typical UV-A filters are in particular derivatives of benzoylmethane, such as, for example, 1-(4′-tert-butylphenyl)-3-(4′-methoxyphenyl)propane-1,3-dione, 4-tert-butyl-4′-methoxydibenzoylmethane (Parsol 1789), 1-phenyl-3-(4′-isopropylphenyl)propane-1,3-dione and also enamine compounds, as described in DE 19712033 A1 (BASF). The UV-A and UV-B filters can of course also be used as mixtures. In addition to the stated soluble substances, insoluble light-protective pigments, i.e. finely dispersed preferably nanoized metal oxides or salts, are also possible for this purpose. Examples of suitable metal oxides are in particular zinc oxide and titanium dioxide and also oxides of iron, zirconium, silicon, manganese, aluminum and cerium and also mixtures thereof. As salts, silicates (talc), barium sulfate or zinc stearate can be used. The oxides and salts are already used in the form of the pigments for skincare and skin protection emulsions and decorative cosmetics. The particles here should have a mean diameter of less than 100 nm, preferably between 5 and 50 nm and in particular between 15 and 30 nm. They can be spherical in shape, but particles having an ellipsoidal shape or a shape deviating in other ways from the spherical form can also be used. The pigments can also be surface-treated, i.e. hydrophobized or hydrophilized. Typical examples are coated titanium dioxides, such as, for example, titanium dioxide T 805 (Degussa) or Eusolex® T2000 (Merck). Possible hydrophobic coating agents here are above all silicones and specifically trialkoxyoctyl-silanes or simethicones. Preferably, micronized zinc oxide is used. Further suitable UV filters can be found in the review by P. Finkel in SÖFW Journal 122, 543 (1996). UV absorbers are typically used in amounts ranging from 0.01% by weight to 5% by weight and preferably from 0.03% by weight to 1% by weight.

The compositions of the present invention may comprise additional anticrease agents to support the corresponding action of the cellulose ether to be used in accordance with the invention, since textile fabrics, especially those composed of rayon, wool, cotton and blends thereof, can tend to crease because the individual fibers are sensitive to bending, kinking, pressing and squashing transversely to the fiber direction. These include, for example, synthetic products based on fatty acids, fatty acid esters, fatty acid amides, fatty acid alkylolesters, fatty acid alkylolamides or fatty alcohols, which have mostly been reacted with ethylene oxide, or products based on lecithin or modified phosphoric esters.

The inventive compositions may comprise graying inhibitors. These are designed to keep the soil detached from the fiber suspended in the liquor and to prevent its redeposition on the fiber. Useful graying inhibitors include water-soluble colloids mostly organic in nature, for example, glue, gelatin, salts of ether sulfonic acids of starch or of cellulose or salts of acidic sulfuric esters of cellulose or of starch. Similarly, water-soluble polyamides which comprise acidic groups are suitable for this purpose. It is also possible to use soluble starch preparations and starch products other than those mentioned above, for example, degraded starch, aldehyde starches, etc. Polyvinylpyrrolidone can be used as well. However, preference is given to anionic or nonionic cellulose ethers such as carboxymethylcellulose (sodium salt), methylcellulose, hydroxyalkylcellulose and mixed ethers such as methylhydroxyethylcellulose, methylhydroxypropylcellulose and/or methyl-carboxymethylcellulose.

In a particularly preferred embodiment, the inventive textile care compositions, especially liquid laundry detergents, are in the form of a portion in a wholly or partly water-soluble envelope. The portioning facilitates metering for the consumer.

The textile care compositions may be in packaged form, in film pouches, for example. Film pouches composed of water-soluble film make it unnecessary for the consumer to tear open the pack. This permits simple dosing of an individual portion for a wash cycle by placing the pouch directly into the washing machine or by throwing the pouch into a certain amount of water, for example, in a bucket, bowl or basin or sink. The film pouch which surrounds the detergent portion dissolves without residue on attainment of a certain temperature. Laundry detergent compositions packaged in pouches made of water-soluble film have likewise been described in large numbers in the prior art. For instance, German Patent Application DE 198 31 703 discloses a portioned washing or cleaning composition in a pouch of water-soluble film, especially in a pouch of (optionally acetalized) polyvinyl alcohol (PVAL) wherein not less than 70% by weight of the particles of the washing or cleaning composition are >800 μm in size.

Numerous processes for producing water-soluble portions of laundry detergent already exist in the prior art and can in principle also be used in the context of the present invention. The best known process is the tubular film process involving horizontal and vertical sealing seams. Film pouches or dimensionally stable portions of laundry detergent can also be produced by the thermoforming process as described, for example, in WO-A1 00/55068. The water-soluble envelopes need not necessarily consist of a film material, but can also constitute dimensionally stable receptacles, which are obtainable by an injection-molding process, for example. A known process for producing water-soluble injection moldings comprising washing and/or cleaning composition is described, for example, in WO-A1 01/36290.

The prior art further discloses processes for producing water-soluble capsules composed of polyvinyl alcohol or gelatin which in principle make it possible to provide capsules having a high fill level. The processes involve the water-soluble polymer being introduced into a shaping cavity. Filling and sealing of the capsules takes place either concurrently or in successive steps, the filling of the capsules taking place through a small opening in the latter case. Processes wherein filling and sealing take place concurrently are described, for example, in WO 97/35537. The capsules are filled through a filling wedge which is disposed above two counter-rotating drums comprising hemispherical shells on their surface. The drums guide polymeric bands which cover the hemispherical-shell cavities. At the positions where the polymeric band of one drum coincides with the polymeric band of the opposite drum, sealing takes place. In a parallel operation, the charge is injected into the capsule being formed, the pressure of injection of the liquid charge pressing the polymeric bands into the hemispherical-shell cavities. A process for producing water-soluble capsules where filling is a first step and sealing a second step is disclosed in WO 01/64421. The production operation is based on the Bottle-Pack® process as described, for example. in German published specification DE 14 114 69. It involves a tubular preform being led into a two-part cavity. The cavity is closed to seal the lower tube section and subsequently the tube is expanded to fill out the capsule situated in the cavity, filled and finally sealed.

The envelope material used for producing the water-soluble portion is preferably a water-soluble polymeric thermoplastic, more preferably selected from the group consisting of (optionally partially acetalized) polyvinyl alcohol, polyvinyl alcohol copolymers, polyvinyl-pyrrolidone, polyethylene oxide, gelatin, cellulose and its derivatives, starch and its derivatives, blends and composites, inorganic salts and mixtures thereof, preferably hydroxypropylmethylcellulose and/or polyvinyl alcohol blends.

In one embodiment of the invention, the envelope material may consist wholly or partly of the cellulose ether to be used in the textile care composition in accordance with the invention.

The above-described polyvinyl alcohols are commercially available, for example, under the trademark Mowiol® (Clariant). Polyvinyl alcohols which are particularly useful in the present invention are, for example, Mowiol® 3-83, Mowiol® 4-88, Mowiol® 5-88, Mowiol® 8-88 and also Clariant L648.

The water-soluble thermoplastic used for producing the portion according to the present invention may further optionally comprise polymers selected from the group comprising acrylic acid-containing polymers, polyacrylamides, oxazoline polymers, polystyrenesulfonates, polyurethanes, polyesters, polyethers and/or mixtures thereof. It is preferable when the water-soluble thermoplastic used comprises a polyvinyl alcohol whose degree of hydrolysis is in the range from 70 to 100 mol %, preferably from 80 to 90 mol %, more preferably from 81 to 89 mol % and especially from 82 to 88 mol %. It is further preferable when the water-soluble thermoplastic used comprises a polyvinyl alcohol whose molecular weight is in the range from 10,000 to 100,000 gmol⁻¹, preferably from 11,000 to 90,000 gmol⁻¹, more preferably from 12,000 to 80,000 gmol⁻¹ and especially from 13,000 to 70,000 gmol⁻¹. It is further preferable when the thermoplastic is present in amounts of not less than 50% by weight, preferably not less than 70% by weight, more preferably not less than 80% by weight and especially not less than 90% by weight, each percentage being based on the weight of the water-soluble polymeric thermoplastic. Polymeric thermoplastics may comprise plasticizers to improve their processibility. This can be of advantage in particular when the polymeric material used for the portion was polyvinyl alcohol or partially hydrolyzed polyvinyl acetate. Useful plasticizers include in particular glycerol, triethanolamine, ethylene glycol, propylene glycol, diethylene glycol, dipropylene glycol, diethanolamine and methyldiethylamine. It is advantageous when the polymeric thermoplastics comprise plasticizers in amounts not less than >0% by weight, preferably of ≧10% by weight, more preferably of ≧20% by weight and especially of ≧30% by weight, each percentage being based on the weight of the envelope material.

The invention further provides for the use of a cellulose ether to be used in accordance with the invention in a textile care composition for reducing fuzz formation.

The invention further provides for the use of a cellulose ether to be used in accordance with the invention in a textile care composition for reducing pill formation in textile fabrics.

The invention further provides for the use of a cellulose ether to be used in accordance with the invention in a textile care composition for easy ironing of textile fabrics.

Surprisingly, it has additionally been found that the cellulose ethers to be used in accordance with the invention do not just reduce crease formation and ensure a smooth textile surface but additionally considerably improve the softness of the treated textiles.

The invention therefore further provides for the use of a cellulose ether to be used in accordance with the invention in a textile care composition for crease reduction, smoothing and improving the softness of textile fabrics.

The invention further provides a conditioning substrate, which is a substrate which has been impregnated and/or saturated with the inventive textile care composition.

The substrate material consists of porous materials which are capable of reversibly absorbing and releasing an impregnation fluid. Useful fabrics for this purpose are both three-dimensional fabrics, for example, sponges, but preferably porous, flat cloths. They may consist of a fibrous or cellular flexible material which has sufficient thermal stability for use in the dryer and which can retain sufficient amounts of an impregnating or coating composition in order to condition substances effectively without significant leaking or leaching of the composition during storage. These cloths include cloths made of woven and nonwoven synthetic and natural fibers, felt, paper or foam, such as hydrophilic polyurethane foam.

Preference is given here to using conventional cloths made of nonwoven material (nonwovens). Nonwovens are generally defined as adhesively bonded fibrous products which have a mat or coated fiber structure, or those which comprise fiber mats in which the fibers are distributed randomly or in statistic arrangement. The fibers may be natural, such as wool, silk, jute, hemp, cotton, linen, sisal or ramie; or may have been produced synthetically, such as rayon, cellulose esters, polyvinyl derivatives, polyolefins, polyamides, viscose or polyesters. In general, any fiber diameter and linear density is suitable for the present invention. Preferred inventive conditioning substrates consist of a nonwoven material which comprises cellulose. Owing to the random or statistical arrangement of fibers in the nonwoven material, which impart excellent strength in all directions, the nonwoven substances used here do not tend to tear or disintegrate when they are used, for example, in a domestic laundry dryer. Examples of nonwoven substances which are suitable as substrates in the present invention are known, for example, from WO 93/23603. Preferred porous and flat conditioning cloths consist of one or different fiber materials, in particular of cotton, finished cotton, polyamide, polyesters or mixtures thereof. The conditioning substrates in cloth form preferably have a surface area of from 0.2 to 0.005 m², preferably from 0.15 to 0.01 m², in particular from 0.1 to 0.03 m² and more preferably from 0.09 to 0.06 m². The grammature of the material is typically between 20 and 500 g/m², preferably from 25 to 200 g/m², in particular from 30 to 100 g/m² and more preferably from 40 to 80 g/m².

The invention further provides a conditioning process for conditioning damp textiles by means of the inventive conditioning substrate.

The conditioning process is performed by using the inventive conditioning substrate together with damp textiles, which originate, for example, from a preceding wash process, in a textile drying process. The textile drying process takes place typically in a device for drying textiles, preferably in a domestic tumble dryer.

The invention further provides processes for reducing fuzz formation, for reducing pill formation, for easy ironing, for crease reduction, smoothing and/or improvement of the softness of textile fabrics by contacting textile fabrics with an inventive textile care composition and/or an inventive conditioning substrate in a textile cleaning process and/or textile drying process.

The inventive textile care compositions may, in their conditioning aspect, be added directly with the damp laundry into a domestic dryer and/or a washing machine.

The inventive textile care compositions can be produced by simple mixing and stirring of the individual components familiar to the person skilled in the art. The cellulose ethers to be used in accordance with the invention may be added as a solution or slurry, preferably in aqueous form, to a composition, especially a liquid composition, and/or as a dried powder, preferably applied to a laundry detergent constituent as a carrier, compounded or granulated, mixed or tableted or pelleted.

### EXAMPLES

Table 1 shows the inventive liquid formulation M1 and the comparative formulation V1. All data are in percent by weight, based in each case on the overall composition.

TABLE 1

| | M1 | V1 |
|---|---|---|
| C₁₂₋₁₄ sodium alkyl ether sulfate | 5 | 5 |
| C₁₂-C₁₈ fatty alcohol + 7 EO | 12 | 12 |
| C₁₄₋₁₆ alkyl glucoside | 2 | 2 |
| C₁₂₋₁₈ soap (sodium salt) | 5 | 5 |
| Trisodium citrate | 2 | 2 |
| Glycerol | 5 | 5 |
| Cellulose ether^{[a]} | 1 | — |
| Water | to 100 | to 100 |

^{[a]}Quaternized hydroxyethylcellulose (Ucare ® LK, manufacturer: Dow Chemicals)

The test textiles specified in Table 2 below were washed with 120 g of the particular composition [water hardness: 16° GH] (Miele W985; boil/color wash program 40° C./spinning: 900 rpm) and then dried (2 days hanging on a line in a climate-controlled room at 20° C. and 65% air humidity).

The washing and drying cycles were repeated 4 times each (i.e. 5 washing/drying cycles in total).

The textile to be tested was stretched in a Dynamometer (Hounsfield H5KS) by 80% of the original length for 1 minute, then released for 3 minutes, and the remaining residual stretch was then measured. In Table 2 below, the reduction in the residual stretch (S) as a result of the use of the composition M1 in relation to the residual stretch (S₀) of the textile in the case of use of V1 is reported by the formula
Reduction in residual stretch=100×(S₀—S)/S₀

TABLE 2
Reduction in residual stretch

| | Reduction in |
|---|---|
| Textile | residual stretch |
| Black pullover (100% cotton) | 8 |
| Blue vest (50% cotton/50% PAC) | 26 |
| Black roll-neck top (76% viscose/19% PA/5% elastane) | 33 |
| Blue pullover (70% cotton/30% PES) | 29 |

It can be seen that the use of the inventive composition leads to a significant improvement in the elasticity.

### Example 2

### Determination of the Creasing of Textiles

Table 3 shows the inventive all-purpose laundry detergent formulation M2 and the comparative formulation V2. All data are in percent by weight, based in each case on the overall composition.

TABLE 3

| | M2 | V2 |
|---|---|---|
| Sodium alkylbenzenesulfonate | 12 | 12 |
| C₁₂-C₁₈fatty alcohol + 7 EO | 3 | 3 |
| C₁₂₋₁₈soap (sodium salt) | 1 | 1 |
| Sodium percarbonate | 13 | 13 |
| TAED | 3 | 3 |
| Citric acid | 1 | 1 |
| Sodium silicate | 5 | 5 |
| Sodium polyacrylate | 3 | 3 |
| Phosphonic acid | 1 | 1 |
| Sodium carbonate | 20 | 20 |
| Sodium hydrogencarbonate | 5 | 5 |
| Cellulose ether^{[b]} | 2 | — |
| Sodium sulfate | to 100 | to 100 |

^{[a]}Quaternized hydroxyethylcellulose (Ucare ® JR 30M, manufacturer: Dow Chemicals)

The creasing was determined based on the AATCC Test 124 (American Association of Textile and Colour Chemistry) after the washing process and drying process which followed, by assessment of the creasing of the test fabric relative to creased standard fabric (AATCC124) by a panel of five people. The mark 5 is given for crease-free fabric and the mark 1 for highly creased fabric. The overall mark is the arithmetic mean of the evaluations.

The test fabric (textile: bleached cheesecloth; 100% cotton; 1.0 m*0.9 m) was treated with the formulations M2 and the comparative formulation without textile care component V2 as follows:

3 fabric pieces were washed with 109 g of the particular formulation [water hardness: 16° GH (Miele Novotronik W918; wash program: standard cotton/color 60° C./spinning: 900 rpm) and then dried (2 days hanging on a line in a climate-controlled room at 20° C. and 65% air humidity).

The washing and drying cycles were each repeated twice (i.e. 3 washing/drying cycles in total).

TABLE 4
Evaluation of the creases

| Test fabric treated with | M2 | V2 |
|---|---|---|
| Crease evaluation [mark] | 2.1 | 1.4 |

For the inventive formulation M2, significantly reduced creasing is found in comparison to V2.

### Example 3

### Determination of the Force to be Expended for the Ironing of Textiles (Easy Ironing)

To determine the force of sliding friction which has to be expended to iron a textile, a conventional Rowenta P2 Professional iron was moved by a Zwick universal testing maching (type 2.5/TN1P) over the fabric in longitudinal direction with a speed of 800 mm per minute via a deflecting roller. The temperature of the iron was adjusted to level III. The weight applied by the 1680 g iron was increased by additional weights to 2940 g. The force required to move the iron in [N] was measured.

A test fabric (bleached cheesecloth; 100% cotton) was treated as follows with the formulations M2 and V2 detailed in Example 2:

6 fabric strips were washed with 109 g of the particular composition [water hardness: 16° GH] (Miele Novotronik W918; wash program: standard cotton/color 60° C./spinning: 900 rpm) and then dried (2 days hanging on a line in a climate-controlled room at 20° C. and 65% air humidity).

The washing and drying cycles were each repeated twice (i.e. 3 washing/drying cycles in total).

TABLE 5
Forces of sliding friction

| Test fabric treated with | M2 | V2 |
|---|---|---|
| Force measured [N] | 8.15 | 13.0 |

For the inventive formulation M2, significantly easier ironing was found in comparison to V2.

1. A textile care composition comprising quaternary nitrogen-containing cellulose ethers of the general formula (I)
((R—O—)₃R_{cell})_{y} (I)
in which R_{cell} is an anhydroglucose radical (C₆H₁₀O₅), the degree of polymerization y is from 50 to 20,000, and each of the R radicals corresponds to the general formula (II) 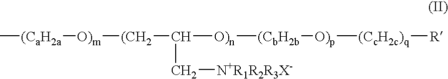
in which a and b are each independently 2 or 3, c is 1, 2 or 3, m and p are each independently an integer from 0 to 10, n is an integer from 0 to 3, q is 0 or 1, X⁻ is an anion which, according to its charge, is present in such a number that it balances the positive charges of the quaternary nitrogen atoms, and R′ is hydrogen, a carboxylic acid group or a sodium carboxylate, potassium carboxylate or ammonium carboxylate group, with the proviso that R′ is hydrogen when q is 0.

2. The composition as claimed in claim 1, characterized in that the composition comprises from 0.1% by weight to 5% by weight of quaternary nitrogen-containing cellulose ethers of the general formula (I).

3. The composition as claimed in claim 1, characterized in that y in the compounds of the formula (I) is in the range from 200 to 5,000.

4. The composition as claimed in claim 1, characterized in that n, as a mean value in the compounds of the formula (I), per anhydroglucose unit R_{cell}, is from 0.01 to 1, in particular from 0.1 to 0.5.

5. The composition as claimed in claim 1, wherein the sum of m, n, p and q, per anhydroglucose unit R_{cell}, as a mean value, is from 0.01 to 4.

6. The composition as claimed in claim 1, characterized in that the compounds of the formula (I) contain, in addition to the groups bearing the quaternary nitrogen atom, methyl, ethyl, propyl, hydroxyethyl and/or hydroxypropyl groups.

7. The composition as claimed in claim 1, characterized in that the compound of the formula (I) has a mean molecular weight Mw of above 5,000.

8. The composition as claimed in claim 7, characterized in that the compound of the formula (I) has a mean molecular weight Mw between 30,000 and 250,000 g/mol.

9. The composition as claimed in claim 1, characterized in that the composition further comprises complexing agents.

10. The composition as claimed in claim 1, characterized in that the composition is present in solid or liquid form.

11. The composition as claimed in claim 1, characterized in that the composition further comprises an enzyme.

12. The composition as claimed in claim 1, characterized in that the composition is present as a portion in a full or partial water-soluble envelope.

13. A process for conditioning textile fabric comprising the step of applying to the fabric a textile care composition comprising a quaternary nitrogen-containing cellulose ether of the general formula I.

14. The process as claimed in claim 13, wherein the conditioning of textile fabrics includes the reduction of fuzz formation and/or pill formation.

15. A process for easy ironing of textile fabric comprising the step of applying to the fabric a textile care composition comprising a quaternary nitrogen-containing cellulose ether of the general formula I.

16. A process for crease reduction, smoothing and improving the softness of textile fabric comprising the step of applying to the fabric a textile care composition comprising a quaternary nitrogen-containing cellulose ether of the general formula I.

17. A process for reducing fuzz formation of textile fabrics by contacting textile fabrics with a textile care composition as claimed in claim 1 in a textile cleaning process and/or textile drying process during the steps of cleaning the textile fabric and/or drying the textile fabric.

18. A conditioning substrate comprising porous materials capable of reversibly absorbing and releasing the textile care composition of claim 1.

19. The conditioning substrate of claim 18, wherein the porous materials are cloths made from at least one of woven and non-woven synthetic and natural fibers, felt, paper and foam.

20. The conditioning substrate of claim 19, wherein the cloths are made from non-woven fibers.
